(19) United States
(12) Patent Application Publication
(10) Pub. No.: US 2008/0308722 A1
(43) Pub. Date: Dec. 18, 2008

(54) ELECTROSPRAY-ASSISTED LASER-INDUCED ACOUSTIC DESORPTION IONIZATION MASS SPECTROMETER AND A METHOD FOR MASS SPECTROMETRY

(75) Inventor: Jentaie SHIEA, Kaohsiung City (TW)

Correspondence Address: FOLEY AND LARDNER LLP;SUITE 500, 3000 K STREET NW, WASHINGTON, DC, 20007, US

(73) Assignee: National Sun Yat-Sen University

(21) Appl. No.: 12/112,532

(22) Filed: Apr. 30, 2008

(30) Foreign Application Priority Data
Apr. 30, 2007 (TW) 096115326

(51) Int. Cl. B01D 59/44

(52) U.S. Cl. 250/281

(57) ABSTRACT

A mass spectrometer includes: an electrospray unit for forming liquid drops of an electrospray medium; a voltage supplying member disposed to allow the liquid drops to be laden with a plurality of charges for heading toward a receiving unit along a traveling path; a substrate having a sample surface for placement of a sample and an irradiated surface opposite to the sample surface; and a laser transmission mechanism for irradiating the irradiated surface. The substrate permits propagation of laser energy therethrough such that laser energy is passed on to at least one analyte in the sample via the substrate so that the analyte is desorbed to fly along a flying path intersecting the traveling path to enable occlusion of the analyte in the liquid drops. As a result of dwindling in size of the liquid drops, charges will pass on to the analyte to form a corresponding ionized analyte.

### CROSS-REFERENCE TO RELATED APPLICATION

This application claims priority of Taiwanese Application No. 096115326, filed on Apr. 30, 2007.

### BACKGROUND OF THE INVENTION

1. Field of the Invention

The invention relates to a method for mass spectrometry and a mass spectrometer for implementing the same, more particularly to a method of electrospray-assisted laser-induced acoustic desorption ionization mass spectrometry and an electrospray-assisted laser-induced acoustic desorption ionization mass spectrometer.

2. Description of the Related Art

Mass spectrometric analysis is widely used as an identification tool in various fields, especially for protein identification. One of the most common method for mass spectrometry is matrix-assisted laser desorption ionization mass spectrometry (MALDI-MS). However, MALDI-MS involves tedious and time-consuming pre-processing on samples subject to analysis. In addition, co-crystallization of sample and matrix influences reproducibility of MALDI-MS results.

The applicant has developed a method called electrospray-assisted laser desorption ionization mass spectrometry (ELDI-MS), which is capable of successfully identifying proteins contained in a sample by virtue of direct laser irradiation on the sample (laser desorption (LD)).

However, according to academic papers, such as Katta, V.; Chow, D. T.; and Rohde, M. F. Anal. Chem., 1998, 70, 4410-4416, direct laser irradiation on protein molecules results in breaking of the protein molecules into several pieces of peptides. Although with reference to information recorded in relevant databases, etc., the peptide signals can be combined to perform protein identification, variations among breakings of the same type of protein molecules into peptides produce many types of peptides. The large number of combinations of these peptides into different protein molecules generates a difficulty in protein identification.

Laser-induced acoustic desorption mass spectrometry (LIAD-MS) involves the production of acoustic waves by irradiation of laser on a substrate, and the propagation of laser energy to a sample to thereby desorb analytes contained in the sample in the form of ions.

As compared to LD, LIAD is a more gentle way of desorbing analytes contained in the sample. In addition, there is a greater chance that the desorbed analytes and ions obtained through LIAD have a complete structure. However, in LIAD, the desorbed analytes are mostly in the form of neutral particles, i.e., ionization efficiency of LIAD is extremely low. This extremely low ionization efficiency results in extremely weak signals, and therefore is vulnerable to noise interference, resulting in poor detection sensitivity and poor reproducibility in LIAD. Consequently, analysis results of LIAD generally lack objectiveness and representation.

Therefore, there is a need for a method of mass spectrometry that provides desorbed analytes with complete structures, that enhances ionization efficiency, and that is capable of conducting rapid, convenient, and accurate analysis.

### SUMMARY OF THE INVENTION

Therefore, the object of the present invention is to provide an ionization device, a mass spectrometer, and a method for mass spectrometry that are capable of overcoming the aforesaid drawbacks associated with the prior art.

According to one aspect of the present invention, there is provided a mass spectrometer that includes a receiving unit, an electrospray unit, a voltage supplying member, a substrate, and a laser transmission mechanism.

The receiving unit is disposed to admit therein ionized analytes that are derived from a sample, and includes a mass analyzer disposed for analyzing the ionized analytes.

The electrospray unit includes a reservoir for accommodating a liquid electrospray medium, and a nozzle which is disposed downstream of the reservoir, and which is configured to sequentially form a liquid drop of the electrospray medium thereat. The nozzle is spaced apart from the receiving unit in a longitudinal direction so as to define a traveling path.

The voltage supplying member is disposed to establish between the nozzle and the receiving unit a potential difference which is of an intensity such that the liquid drop is laden with a plurality of charges, and such that the liquid drop is forced to leave the nozzle as a multiple-charged one for heading toward the receiving unit along the traveling path.

The substrate has a sample surface on which the sample is placed, and an irradiated surface opposite to the sample surface.

The laser transmission mechanism is disposed to irradiate the irradiated surface of the substrate.

The substrate is made from a material capable of permitting propagation of laser energy therethrough such that upon irradiation by the laser transmission mechanism, laser energy is passed on to at least one of the analytes contained in the sample via the substrate so that the at least one of the analytes is desorbed to fly along a flying path which intersects the traveling path of the multiple-charged liquid drops of the electrospray medium so as to enable the at least one of the analytes to be occluded in the multiple-charged liquid drops.

As a result of dwindling in size of the multiple-charged liquid drops when approaching the receiving unit from the nozzle of the electrospray unit along the traveling path, charges of the liquid drops will pass on to the at least one of the analytes occluded therein to form a corresponding one of the ionized analytes.

According to another aspect of the present invention, there is provided a method for mass spectrometry that includes the steps of: (a) providing a substrate that has a sample surface and an irradiated surface opposite to the sample surface, the substrate being made from a material capable of permitting propagation of laser energy therethrough; (b) providing a sample that is placed on the sample surface of the substrate; (c) providing a receiving unit that is disposed to admit therein ionized analytes derived from the sample, and that includes a mass analyzer disposed for analyzing the ionized analytes; (d) providing an electrospray unit that includes a reservoir for accommodating a liquid electrospray medium, and a nozzle which is disposed downstream of the reservoir, and which is configured to sequentially form a liquid drop of the electrospray medium thereat, the nozzle being spaced apart from the receiving unit in a longitudinal direction so as to define a traveling path; (e) providing a voltage supplying member that is disposed to establish between the nozzle and the receiving unit a potential difference which is of an intensity such that the liquid drop is laden with a plurality of charges, and such that the liquid drop is forced to leave the nozzle as a multiple-charged one for heading toward the receiving unit along the traveling path; and (f) providing a laser transmission mechanism that is disposed to irradiate the irradiated surface of the substrate such that, upon irradiating the irradiated surface of the substrate, laser energy is passed on to at least one of the analytes contained in the sample via the substrate so that the at least one of the analytes is desorbed to fly along a flying path which intersects the traveling path of the multiple-charged liquid drops of the electrospray medium so as to enable the at least one of the analytes to be occluded in the multiple-charged liquid drops, and such that as a result of dwindling in size of the multiple-charged liquid drops when approaching the receiving unit from the nozzle of the electrospray unit along the traveling path, charges of the liquid drops will pass on to the at least one of the analytes occluded therein to form a corresponding one of the ionized analytes.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic diagram of the preferred embodiment of amass spectrometer according to the present invention;

FIG. 2 is an enlarged schematic diagram of a portion of the mass spectrometer enveloped by the dotted line in FIG. 1, illustrating relative positions of components of the mass spectrometer;

FIG. 3 is a schematic diagram, illustrating desorption of analytes contained in a sample so as to fly along a flying path that intersects a traveling path of multiple-charged liquid drops;

FIG. 4 is a mass spectrum, illustrating an experiment result of experiment 1;

FIG. 5 is a mass spectrum, illustrating an experiment result of experiment 2;

FIG. 6 is a mass spectrum, illustrating an experiment result of experiment 3;

FIG. 7 is a mass spectrum, illustrating an experiment result of experiment 4;

FIG. 8 is a mass spectrum, illustrating an experiment result of experiment 5;

FIG. 9 is a mass spectrum, illustrating an experiment result of experiment 6;

FIG. 10 is a mass spectrum, illustrating an experiment result of experiment 7;

FIG. 11 is a mass spectrum, illustrating an experiment result of experiment 8;

FIG. 12 is a convoluted mass spectrum of FIG. 11;

FIG. 13 is amass spectrum, illustrating an experiment result of experiment 9;

FIG. 14 is a mass spectrum, illustrating an experiment result of experiment 10;

FIG. 15 is amass spectrum, illustrating an experiment result of experiment 11;

FIG. 16 is a mass spectrum, illustrating an experiment result of experiment 12;

FIG. 17 is a mass spectrum, illustrating an experiment result of experiment 13;

FIG. 18 is a mass spectrum, illustrating an experiment result of experiment 14;

FIG. 19 is a mass spectrum, illustrating an experiment result of experiment 15;

FIG. 20 is a mass spectrum, illustrating an experiment result of experiment 16;

FIG. 21 is a mass spectrum, illustrating an experiment result of experiment 17;

FIG. 22 is a mass spectrum, illustrating an experiment result of experiment 18;

FIG. 23 is a mass spectrum, illustrating an experiment result of experiment 19;

FIG. 24 is a mass spectrum, illustrating an experiment result of experiment 20;

FIG. 25 is a convoluted mass spectrum of FIG. 24;

FIG. 26 is a mass spectrum, illustrating an experiment result of experiment 21;

FIG. 27 is amass spectrum, illustrating an experiment result of experiment 22;

FIG. 28 is a mass spectrum, illustrating an experiment result of application 1;

FIG. 29 is a mass spectrum, illustrating an experiment result of application 2;

FIG. 30 is a mass spectrum, illustrating an experiment result of application 3;

FIG. 31 is a mass spectrum, illustrating an experiment result of application 4;

FIG. 32 is a mass spectrum, illustrating an experiment result of application 5;

FIG. 33 is a mass spectrum, illustrating an experiment result of application 6;

FIG. 34 is a mass spectrum, illustrating an experiment result of application 7;

FIG. 35 is a mass spectrum, illustrating an experiment result of application 8;

FIG. 36 is a mass spectrum, illustrating an experiment result of application 9;

FIG. 37 is a mass spectrum, illustrating an experiment result of application 10;

FIG. 38 is a mass spectrum, illustrating an experiment result of application 11;

FIG. 39 is a mass spectrum, illustrating an experiment result of application 12;

FIG. 40 is amass spectrum, illustrating an experiment result of application 13;

FIG. 41 is a mass spectrum, illustrating an experiment result of application 14; and

FIG. 42 is a convoluted mass spectrum of FIG. 41.

### DETAILED DESCRIPTION OF THE PREFERRED EMBODIMENTS

Before the present invention is described in greater detail, it should be noted herein that like elements are denoted by the same reference numerals throughout the disclosure.

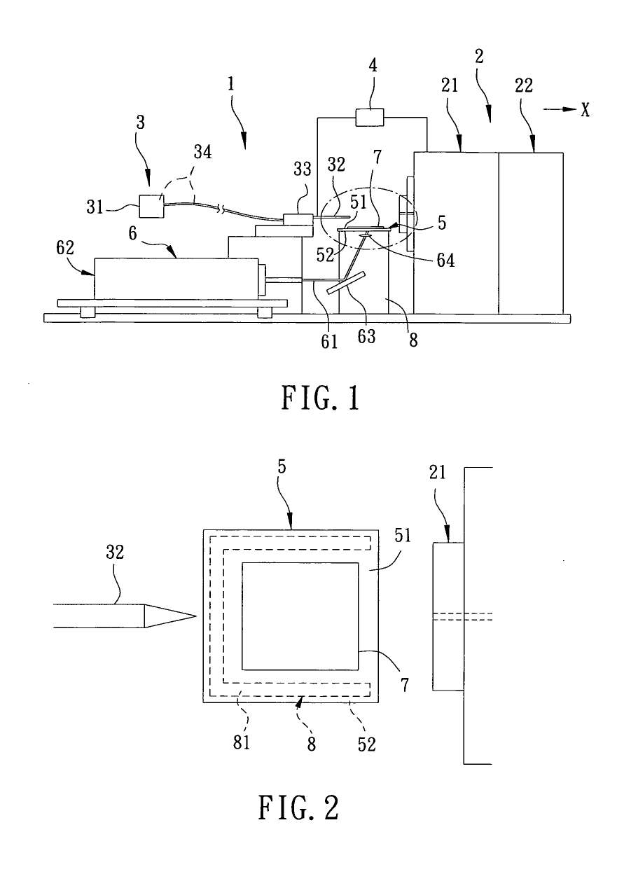

According to the preferred embodiment of the present invention, the method for mass spectrometry, also referred to as the method of electrospray-assisted laser-induced acoustic desorption ionization mass spectrometry, according to the present invention is implemented by a mass spectrometer 1 of FIG. 1. The mass spectrometer 1 includes a receiving unit 2, an electrospray unit 3, a voltage supplying member 4, a substrate 5, and a laser transmission mechanism 6.

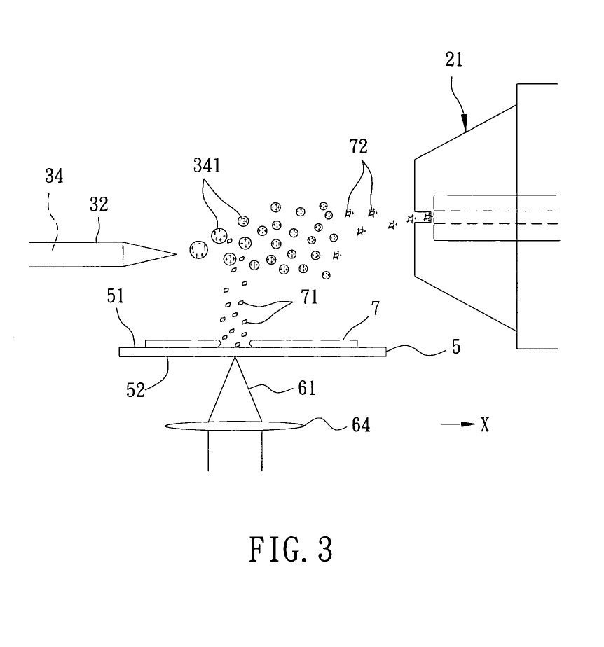

With reference to FIG. 1 and FIG. 3, the receiving unit 2 is disposed to admit therein ionized analytes 71 that are derived from a sample 7. The receiving unit 2 includes a mass analyzer 21 disposed for analyzing the ionized analytes 71, and a detector 22 for detecting signals generated as a result of analyzing the ionized analytes 71 by the mass analyzer 21, and for generating a mass spectrum from the signals.

The electrospray unit 3 includes a reservoir 31, a nozzle 32, and a pump 33. The reservoir 31 accommodates a liquid electrospray medium 34. The nozzle 32 is disposed downstream of the reservoir 31, and is configured to sequentially form a liquid drop 341 of the electrospray medium 34 thereat. The pump 33 is disposed downstream of the reservoir 31 and upstream of the nozzle 32 for drawing the electrospray medium 34 into the nozzle 32. The nozzle 32 is spaced apart from the receiving unit 2 in a longitudinal direction (X) so as to define a traveling path.

The voltage supplying member 4 is disposed to establish between the nozzle 32 and the receiving unit 2 a potential difference which is of an intensity such that the liquid drop 341 is laden with a plurality of charges, and such that the liquid drop 341 is forced to leave the nozzle 32 as a multiple-charged one for heading toward the receiving unit 2 along the traveling path. In this embodiment, the potential difference is established between the nozzle 32 and the mass analyzer 21 of the receiving unit 2.

The substrate 5 has a sample surface 51 on which the sample 7 is placed, and an irradiated surface 52 opposite to the sample surface 51.

The laser transmission mechanism 6 is disposed to irradiate the irradiated surface 52 of the substrate 5. In this embodiment, the laser transmission mechanism 6 includes a laser transmitting unit 62 that is capable of transmitting a laser beam 61, a reflector 63 that is disposed to change the path of the laser beam 61, and a lens 64 that is disposed to receive the laser beam 61 from the reflector 63 for focusing the energy carried by the laser beam 61.

The substrate 5 is made from a material capable of permitting propagation of laser energy therethrough such that upon irradiation by the laser transmission mechanism 6, laser energy of the laser beam 61 is passed on to at least one of the analytes 71 contained in the sample 7 via the substrate 5 so that the at least one of the analytes 71 is desorbed to fly along a flying path which intersects the traveling path of the multiple-charged liquid drops 341 of the electrospray medium 34 so as to enable the at least one of the analytes 71 to be occluded in the multiple-charged liquid drops 341.

As a result of dwindling in size of the multiple-charged liquid drops 341 when approaching the receiving unit 2 from the nozzle 32 of the electrospray unit 3 along the traveling path, charges of the liquid drops 341 will pass on to the at least one of the analytes 71 occluded therein so as to form a corresponding one of the ionized analytes 72.

As shown in FIG. 1 and FIG. 2, a rack 3 is disposed between the nozzle 32 of the electrospray unit 3 and the mass analyzer 21 of the receiving unit 2 for placement of the substrate 5 thereon. In this embodiment, the rack 6 includes a U-shaped support portion 81 that has an open end confronting the mass analyzer 21. The substrate 5 is disposed on the support portion 81 so as to be suspended. In this embodiment, the irradiated surface 52 of the substrate 5 is adhered to the support portion 31.

It should be noted herein that no limitation should be imposed on the shape and the material of the rack a as long as the rack 8 is so structured such that, when the substrate 5 is disposed on the rack 8, the irradiated surface 52 of the substrate 5 is exposed to irradiation by the laser beam 61. In the experiments that follow, the supporting portion 81 of the rack 8 is made from plastic.

As shown in FIG. 1 and FIG. 3, during operation, under the potential difference established by the voltage supplying member 4 between the nozzle 32 of the electrospray unit 3 and the mass analyzer 21 of the receiving unit 2, the liquid drop 341 of the electrospray medium 34 formed at the nozzle 32 is laden with a plurality of charges, and the liquid drop 341 is forced to leave the nozzle 32 as a multiple-charged one for heading toward the receiving unit 2 along the traveling path. On the other hand, the laser transmitting unit 62 of the laser transmission mechanism 6 transmits the laser beam 61 to irradiate the irradiated surface 52 of the substrate 5 such that the laser energy of the laser beam 61 propagates through the substrate 5 and is passed on to the sample 7. Consequently, at least one of the analytes 71 contained in the sample 7 is desorbed to fly along the flying path which intersects the traveling path so as to enable the at least one of the analytes 71 to be occluded in the multiple-charged liquid drops 341. As a result of dwindling in size of the multiple-charged liquid drops 341 when approaching the mass analyzer 21 of the receiving unit 2 from the nozzle 32 along the traveling path, charges of the liquid drops 341 will pass on to the at least one of the analytes 71 occluded therein to form a corresponding one of the ionized analytes 72.

Accordingly, the method for mass spectrometry according to the present invention includes the following steps. In step (a), a substrate 5 is provided and has a sample surface 51 and an irradiated surface 52 opposite to the sample surface 51. The substrate 5 is made from a material capable of permitting propagation of laser energy therethrough. In step (b), a sample 7 is provided to be placed on the sample surface 51 of the substrate 5. In step (c), a receiving unit 2 is provided to be disposed to admit therein ionized analytes 72 derived from the sample 7, and that includes a mass analyzer 21 disposed for analyzing the ionized analytes 72. In step (d), an electrospray unit 3 is provided to include a reservoir 31 for accommodating a liquid electrospray medium 34, and a nozzle 32 which is disposed downstream of the reservoir 31, and which is configured to sequentially form a liquid drop 341 of the electrospray medium 34 thereat. The nozzle 32 is spaced apart from the receiving unit 2 in a longitudinal direction (X) so as to define a traveling path. In step (e), a voltage supplying member 4 is provided to be disposed to establish between the nozzle 32 and the receiving unit 2 a potential difference which is of an intensity such that the liquid drop 341 is laden with a plurality of charges, and such that the liquid drop 341 is forced to leave the nozzle 32 as a multiple-charged one for heading toward the receiving unit 2 along the traveling path. In step (f), a laser transmission mechanism 6 is provided to be disposed to irradiate the irradiated surface 52 of the substrate 5 such that, upon irradiating the irradiated surface 52 of the substrate 5, laser energy is passed on to at least one of the analytes 71 contained in the sample 7 via the substrate 5 so that the at least one of the analytes 71 is desorbed to fly along a flying path which intersects the traveling path of the multiple-charged liquid drops 341 of the electrospray medium 34 so as to enable the at least one of the analytes 71 to be occluded in the multiple-charged liquid drops 341, and such that as a result of dwindling in size of the multiple-charged liquid drops 341 when approaching the receiving unit 2 from the nozzle 32 of the electrospray unit 3 along the traveling path, charges of the liquid drops 341 will pass on to the at least one of the analytes 71 occluded therein to form a corresponding one of the ionized analytes 72.

To improve upon the effects achieved by the present invention, various factors are taken into consideration. It is known from conventional LIAD that the material of the substrate 5 has to have an ablation threshold that is lower than a laser fluence of the laser transmission mechanism 6. Generally, the material of the substrate 5 is metal. In addition, based on factors such as the coefficient of expansion and the coefficient of thermal diffusion, and the reflection coefficient of the laser beam 61, the material of the substrate 5 is optimally selected from the group consisting of titanium, aluminum, iron, gold, silicon (e.g., silicon chip having thickness 500 μm and crystallographic direction (100)), and copper. In particular, it has been verified in scientific paper, Shea, R. C.; Petzold, C. J.; Liu, J-a.; Kenttämaa, H. I. Anal. Chem. 2006, 78, 6133-6139, that any of titanium, copper and gold-made substrate has a higher desorption efficiency. Moreover, in scientific paper, Eliezer, S.; Gilath, I. J. Appl. Phys. 1990, 67, 715-724, satisfactory results were obtained using copper and aluminum substrates that have thicknesses ranging from 100 μm to 600 μm. Further, silicon chip has also been verified to be a viable material for the substrate in LIAD.

In essence, as long as enough energy is absorbed, the analytes 71 can be desorbed. The more energy the analytes 71 absorb, the higher the desorption rate. In particular, thickness of the substrate 5 and laser energy of the laser beam 61 directly affect the desorption of the analytes 71 from the sample 7. In order to prevent unnecessary waste of laser energy, it is preferable that the thickness of the substrate 5 be not greater than 200 μm, and more preferable that the thickness be not greater than 50 μm. In the experiments that follow, the substrate 5 is an aluminum foil paper that has a thickness of approximately 6 μm.

In addition, no limitation is imposed upon the wavelength and frequency of the laser beam 61 transmitted by the laser transmitting unit 62 of the laser transmission mechanism 6. The laser transmitting unit 62 is preferably selected from the group consisting of a nitrogen laser, an argon ion laser, a helium-neon laser, a carbon dioxide (CO₂) laser, a garnet (Nd:YAG) laser and an infrared laser. However, since the degrees of reflection of laser beams 61 with various wavelengths on different materials vary from each other (refer to Shea, R. C.; Petzold, C. J.; Liu, J-a.; Kenttämaa, H. I. Anal. Chem. 2006, 78, 6133-6139), wavelength of the laser beam 61 can be set according to the material of the substrate 5.

Furthermore, no limitation is imposed upon the laser energy of the laser beam 61 transmitted by the laser transmitting unit 62 as long as the laser energy is sufficient such that after propagating through the substrate 5 and passed on to the sample 7, at least one of the analytes 71 is desorbed from the sample 7. Therefore, several factors related to the sample 7, such as thickness of the sample 7 and degree of difficulty of desorbing particular analytes 71 contained in the sample 7, etc., and a unit area of a light spot formed on the irradiated surface 52 of the substrate 5 upon irradiation by the laser transmission mechanism 6, need to be taken into account when determining the range of laser energy to be used. Preferably, the unit area of the light spot has a laser energy of at least 1.11*10⁸ W/cm². More preferably, the unit area of the light spot has a laser energy that ranges from 2.22*10⁸ W/cm² to 1.11*10⁹ W/cm².

In the experiments that follow, the laser transmitting unit 62 is an infrared laser, and the laser beam 61 has a wavelength of 1064 nm, a laser energy of 18 mJ˜40 mJ, and a pulse duration of 9 ns. In addition, the unit area of the light spot has a laser energy that ranges from 3.33*10⁸ W/cm² to 7.4*10⁸ W/cm².

The electrospray medium 34 forming the liquid drops 341 is a solution normally used in electrospray methods, examples of which include solutions containing protons (H⁺) or ions such as OH⁻, etc. Since this aspect should be well known to those skilled in the art, further details of the same are omitted herein for the sake of brevity. In addition, both the positive ion mode and the negative ion mode may be used for the electrospray ionization process.

When the positive ion mode is utilized, the electrospray medium 34 is preferably a solution containing an acid. More preferably, the electrospray medium 34 is a solution containing a volatile liquid such that the liquid portion of the liquid drops 341 can vaporize prior to the receipt of the ionized analytes 72 by the mass analyzer 21 so as to simplify the resultant mass spectrum. Further, in order to help dissolve protein molecules and avoid interference due to an addition of salt in the volatile liquid, the volatile liquid is preferably one with a low polarity, such as isoacetonitrile, acetone, alcohol, etc.

Therefore, preferably, when the positive ion mode is utilized, the electrospray medium 34 is a solution containing an acid and a volatile liquid. More preferably, the acid is an organic acid selected from the group consisting of formic acid, acetic acid, trifluoroacetic acid, and a combination thereof. Still more preferably, the electrospray medium 34 is a solution containing methanol and acetic acid.

On the other hand, when the negative ion mode is utilized, the electrospray medium 34 is preferably an alcohol, a most commonly used example of which is methanol.

In the experiments that follow, the electrospray medium 34 used for the positive ion mode is an aqueous solution containing 50 vol % methanol and 0.1 vol % acetic acid. In addition, it is presumed that the ionized analytes 72 acquired are mostly multivalent with each electric charge contributed by a proton (H⁺). In addition, the electrospray medium 34 used for the negative ion mode is pure methanol.

The method for mass spectrometry according to the present invention is adapted to analyze various substances, including smaller molecules such as amino acid and lipid, and macromolecules (with molecular weights greater than 1000), such as protein. Moreover, the method for mass spectrometry according to the present invention is particularly suitable for performing mass spectrometric analysis on samples containing analytes that are relatively easy to cleave due to external energy impact. Furthermore, the present invention is both applicable to liquid and solid samples.

In the experiments presented in the following, some of the solid samples were obtained after dehydrating a liquid material to be studied, such as standard amino acid or standard protein solution, milk, marker ink, etc. In particular, to prepare such a sample, the liquid material is first smeared on the sample surface 51 of the substrate 5, and then dehydrated under vacuum condition. Further, tissue sections of pig liver and chicken liver were also used as solid samples. In addition, the liquid samples used include standard protein solution (or amino acid solution) and aqueous solutions containing glycerin.

The present invention is described in greater detail hereinbelow with respect to the experiments and exemplary applications presented. It should be noted herein that the experiments and exemplary applications are presented for illustrative purposes only, and should not be taken as limitations imposed on the present invention.

### Chemical and Equipments Used

The experiments and exemplary methods are conducted using the following chemicals and equipments:
1. Methanol: an HPLC solvent manufactured by Sigma-Aldrich company of the United States.
2. Acetic acid; an HPLC solvent manufactured by Sigma-Aldrich company of the United States.
3. Cytochrome c: molecular weight of 12230, an HPLC solvent manufactured by Sigma-Aldrich company of the United States.
4. Methionine: molecular weight of 149.21, model no. M9500, manufactured by Sigma company of the United States.
5. Histidine: molecular weight of 155.16, model no. H7750, manufactured by Sigma company of the United States.
6. Cystine: molecular weight of 121.16, model no. C8630, manufactured by Sigma company of the United States.
7. Asparagines: molecular weight of 132.12, model no. A8256, manufactured by Sigma company of the United States.
8. Lysine; molecular weight of 146.19, model no. L2513, manufactured by Sigma company of the United States.
9. Serine: molecular weight of 105.09, model no. S4375, manufactured by Sigma company of the United States.
10. Angiotensin I (AI); molecular weight of 1296.48, model no. A9650, manufactured by Sigma company of the United States.
11. Insulin: molecular weight of 5733.49, model no. 15500, an HPLC solvent, manufactured by Sigma-Aldrich company of the United States.
12. Myoglobin: molecular weight of 16950, model no. M1882, manufactured by Sigma company of the United States.
13. Hemoglobin: composed of two monomers (two α-chain monomer molecules and two β-chain monomer molecules), molecular weight of α-chain monomer molecule being 15120, molecular weight of β-chain monomer molecule being 15860, model no. H7379, manufactured by Sigma company of the United States.
14. Leucine: molecular weight of 131.17, model no. L7875, manufactured by Sigma company of the United States.
15. Aspartic acid: molecular weight of 133.10, model no. A9006, manufactured by Sigma company of the United States.
16. viagera tablet: effective composition being Sildenafil that has a molecular weight of 474.58, manufactured by Pfizer Pharmaceutical Company of the United States.
17. Glycerin: model no. 2136-01, manufactured by J. T. Baker company of the United States.
18. Aluminum Foil Paper: manufactured by Terinext Siam company.
19. Maker ink (green): manufactured by Lion Pencil Co. Ltd. of Taiwan.
20. Maker ink (red): manufactured by Lion Pencil Co. Ltd. of Taiwan.
21. Maker ink (blue): manufactured by Lion Pencil Co. Ltd. of Taiwan.
22. Milk; produced by Uni-President Co. Ltd. of Taiwan.
23. Laser Transmitting Unit: Infrared (IR) Laser model no. LS-2130SHP, manufactured by LOTIS TII of Russia. The laser beam transmitted by the IR laser has a wavelength of 1064 nm, a frequency of 2 Hz, and a pulse duration of 9 ns.
24. Mass Analyzer (including the Detector): Quadrupole Time-of-Flight Mass Analyzer model no. bio-TOF Q, manufactured by Bruker Dalton company,

It should be noted herein that the molecular weights of the above substances are reference values provided by the manufacturer, and the mass spectrometric analysis results might slightly deviate therefrom due to experimental errors.

The following description will be made with reference to the experiments and exemplary applications conducted to demonstrate the effects achieved by the method for mass spectrometry according to the present invention. The procedures taken for the experiments and exemplary applications are as follows:
1. For a sample that includes both liquid and solid portions, the sample is directly placed on an aluminum foil paper (serving as the substrate 5). For a liquid sample, a 5 μL drop of the liquid sample is smeared on an approximately 1 cm² area of the aluminum foil paper. For a dehydrated sample obtained from a liquid material, a 5 μL drop of the liquid material is first smeared on the aluminum foil paper, and is subsequently dehydrated.
2. When utilizing the positive ion mode, the electrospray medium 34 used in step (d) is an aqueous solution containing 50 vol % methanol and 0.1 vol % acetic acid, while the nozzle 32 is grounded and a −4500V voltage is applied on the mass analyzer 21 by the voltage supplying member 4 in step (e). When utilizing the negative ion mode, the electrospray medium 34 used in step (d) is pure methanol, while the nozzle 32 is grounded and a 4500V voltage is applied on the mass analyzer 21 by the voltage supplying member 4 in step (e). Further, the electrospray medium 5 at flows at a flow rate of 240 μL per hour.
3. The experiments and exemplary applications were carried out as follows:
   <i> Estimation: Prior to conducting each of the experiments and exemplary applications, estimation on the resultant mass spectrum was performed with respect to known analytes contained in the sample.
   <ii> Process: Steps (a) to (f) of the method for mass spectrometry according to the present invention was conducted so as to acquire a mass spectrum.
   <iii> Comparison: A comparison between the estimation and the resulting mass spectrum is made to see if correspondence exists where an allowed error range is ±0.5 for a m/z (mass-to-charge ratio) value. When the correspondence exists, the method for mass spectrometry according to the present invention is verified to be indeed capable of detecting the analytes from the samples. Accordingly, the method for mass spectrometry according to the present invention is proven to be reliable. It should be noted herein that signals detected that are not present in the estimation are background signals.
      Experiment 1—Mass Spectrometric Analysis Conducted on Solid Sample under Positive Ion Mode

In experiment 1, a dehydrated sample obtained from cytochrome C with a concentration of 10⁻⁴M was used. Therefore, prior to conducting experiment 1, it was estimated that the obtained m/z value be (12230+n)/n, where n is an electric charge number of the ionized analytes. A number of examples for the estimated m/z values under 1600 are listed in Table 1.

TABLE 1

| Value of n | (12230 + n)/n |
|---|---|
| 8 | 1529.75 |
| 9 | 1359.89 |
| 10 | 1224 |
| 11 | 1112.82 |
| 12 | 1020.17 |
| 13 | 941.77 |
| 14 | 874.57 |
| 15 | 816.33 |
| 16 | 765.38 |
| 17 | 720.41 |
| 18 | 680.44 |
| 19 | 644.68 |
| 20 | 612.5 |
| 21 | 583.38 |
| 22 | 556.91 |
| 23 | 532.74 |
| — | — |
| — | — |

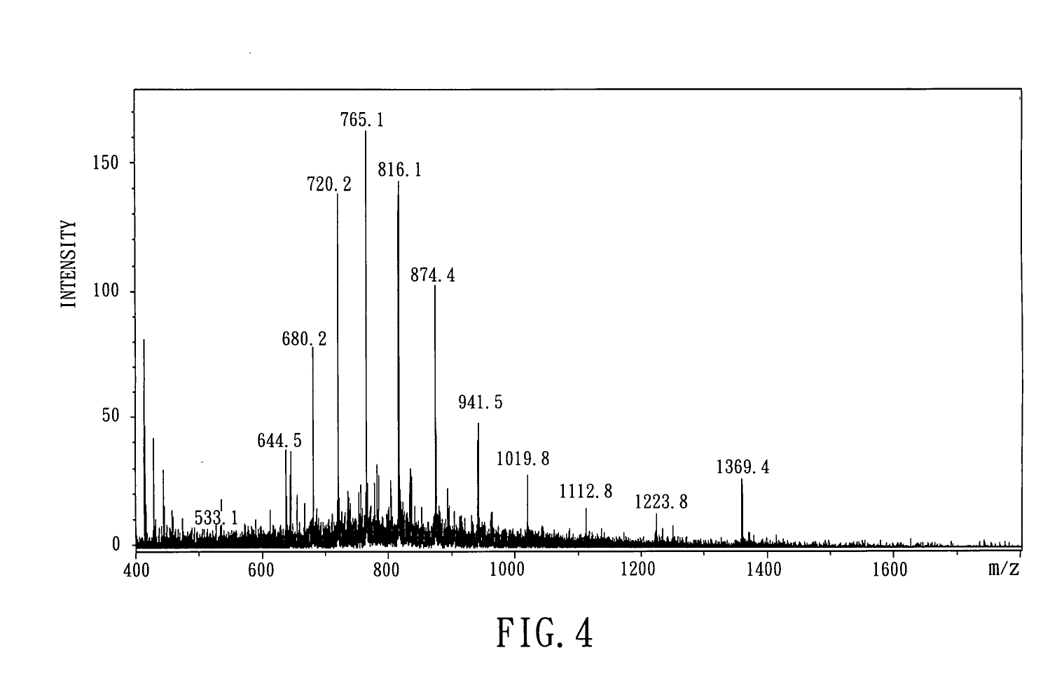

It is verified from FIG. 4 that the laser energy was indeed passed onto the sample via the aluminum foil paper upon irradiation of the latter by the laser beam 61 such that at least one of the analytes contained in the sample was successfully desorbed, and was occluded in the multiple-charged liquid drops formed by the electrospray unit so as to form the ionized analytes, which after analysis by the mass analyzer, generates the high intensity signals found in the mass spectrum. In particular, the signals having m/z values of 533.1 (corresponding to n value of 23), 644.5 (corresponding to n value of 19), 680.2 (corresponding to a value of n of 18), 720.2 (corresponding to a value of n of 17), 765.1 (corresponding to a value of n of 16), 816.1 (corresponding to a value of n of 15), 874.4 (corresponding to a value of n of 14), 941.5 (corresponding to a value of n of 13), 1019.8 (corresponding to a value of n of 12), 1112.8 (corresponding to a value of n of 11), 1223.8 is (corresponding to a value of n of 10), and 1359.4 (corresponding to a value of n of 9), match the estimated signals for cytochrome c. Consequently, the method for mass spectrometry according to the present invention is verified to be practicable.

### Experiments 2˜11—Mass Spetrometric Analysis Conducted on Solid Samples Under Positive Ion Mode

In experiments 2 to 11, dehydrated samples obtained from standard amino acid solutions or standard protein solutions (with a concentration of 10⁻⁴M) were respectively used. The laser energy used, the types of protein (or amino acid), the estimated mass spectrum signals, the figure numbers of the obtained mass spectra, and the detected signals in the obtained mass spectra for experiments 2 to 11 are tabulated in Table 2 that follows, where ‘m’ is the molecular weight of the analytes, and ‘n’ is a positive integer that represents the number of electric charges of the ionized analytes. If a signal having a m/z value of (2 m+1) is present, the analyte is in the form of a dimer, which is a normal phenomenon.

In addition, it was estimated that for experiments 10 and 11 (types of protein being respectively myoglobin and hemoglobin), in addition to the [(m+n)/n] signals, there would also be signals corresponding to an analyte ion that is formed by hematin bonded with a proton (denoted by AH⁺, where ‘A’ represents the analyte) and that has an estimated m/z value of 616.0.

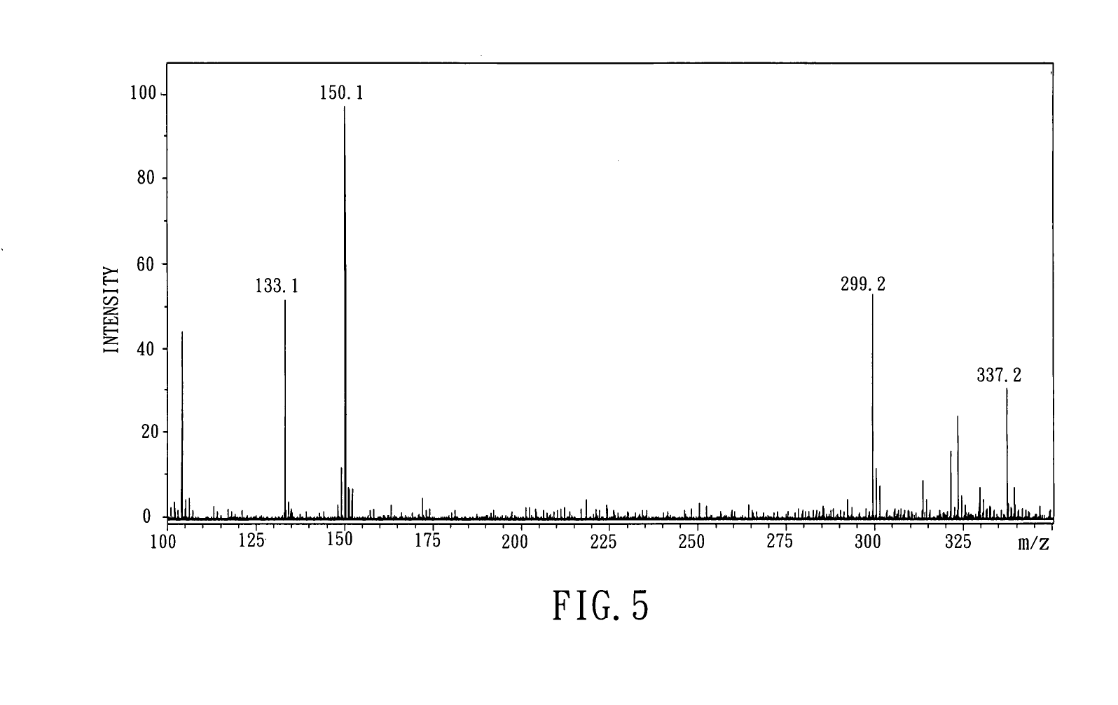

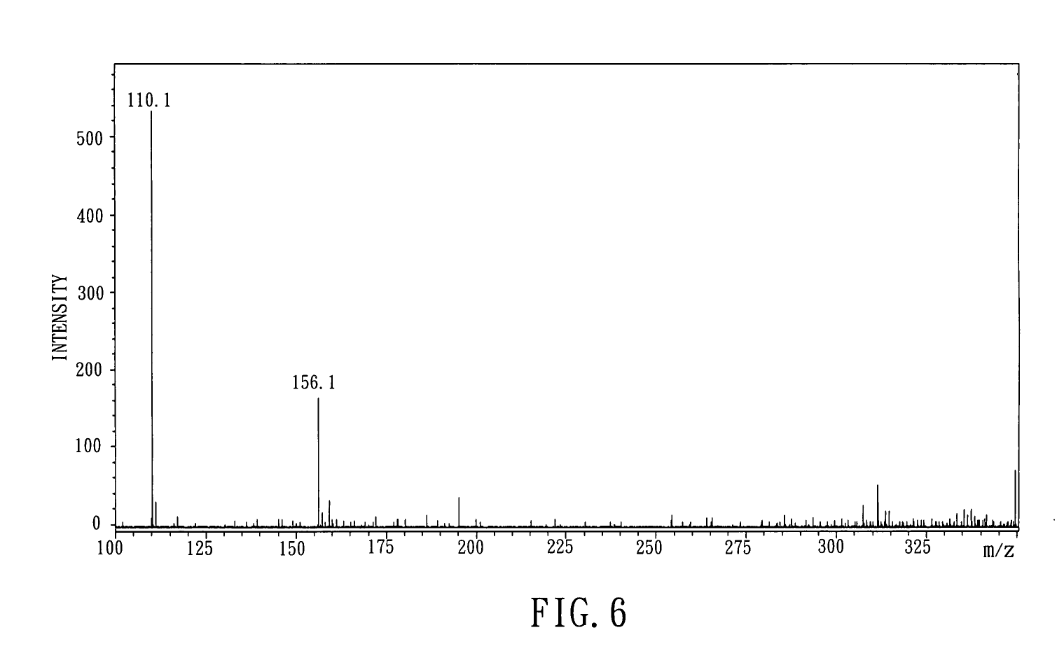

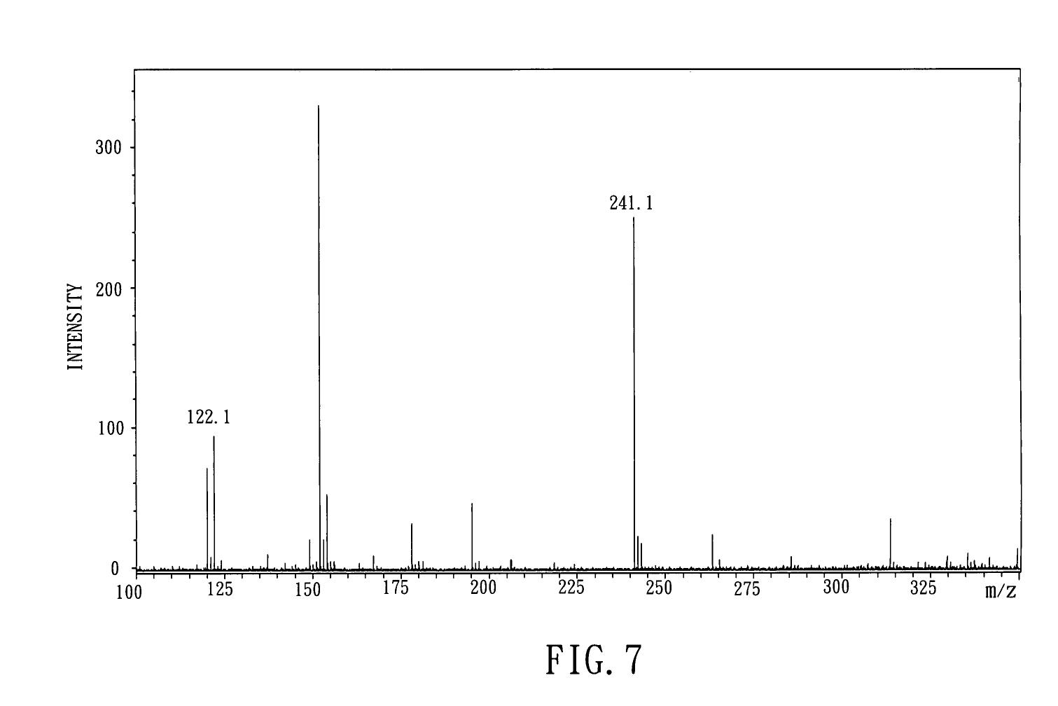

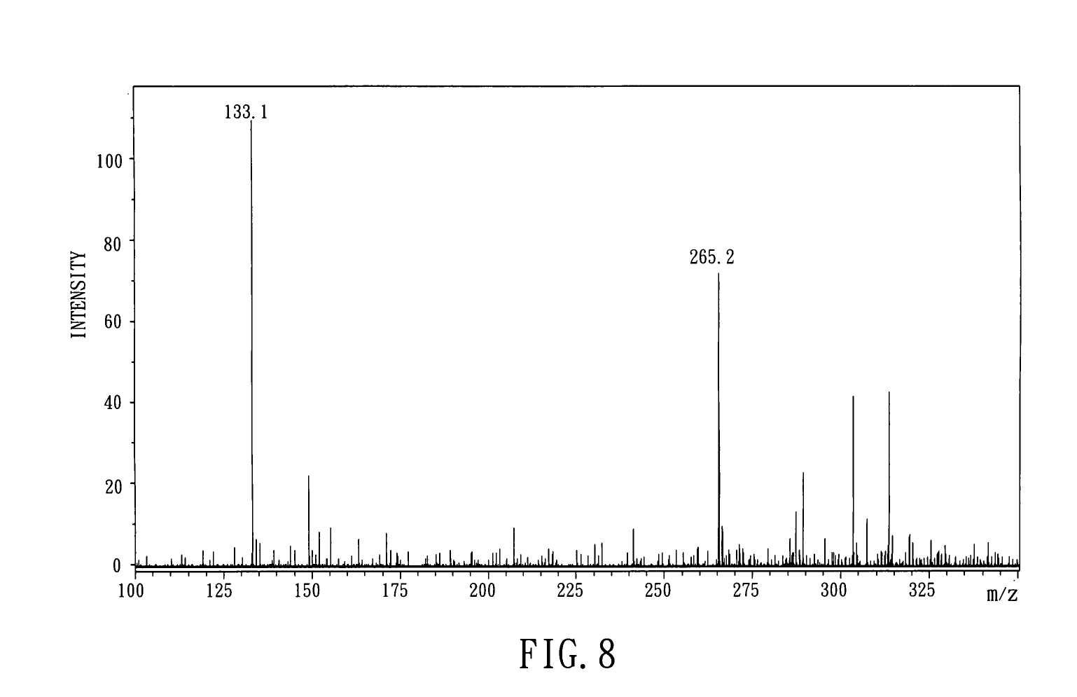

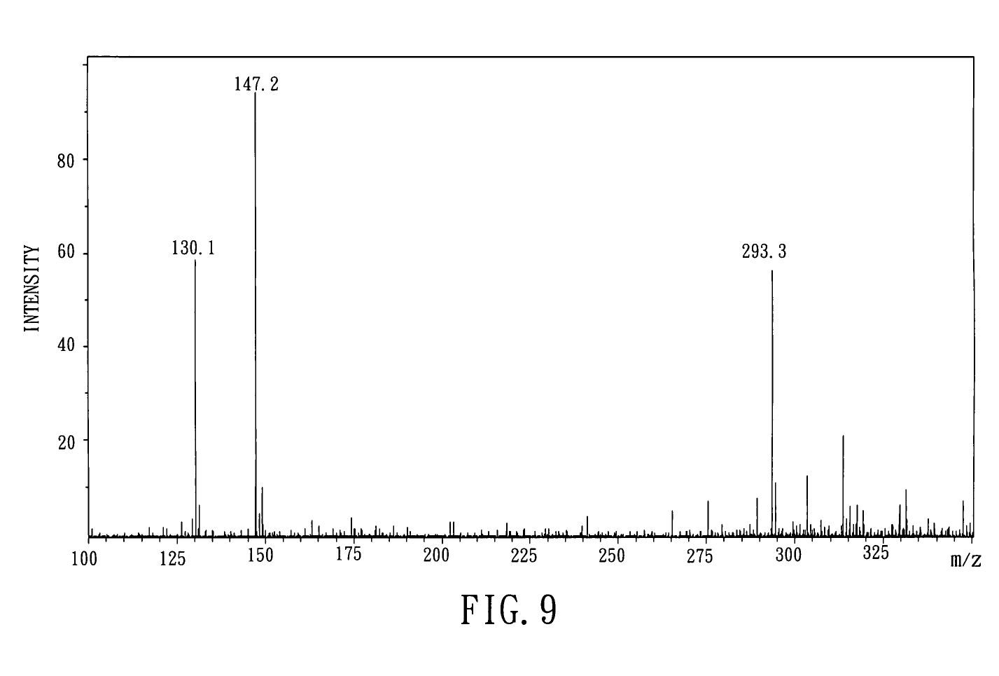

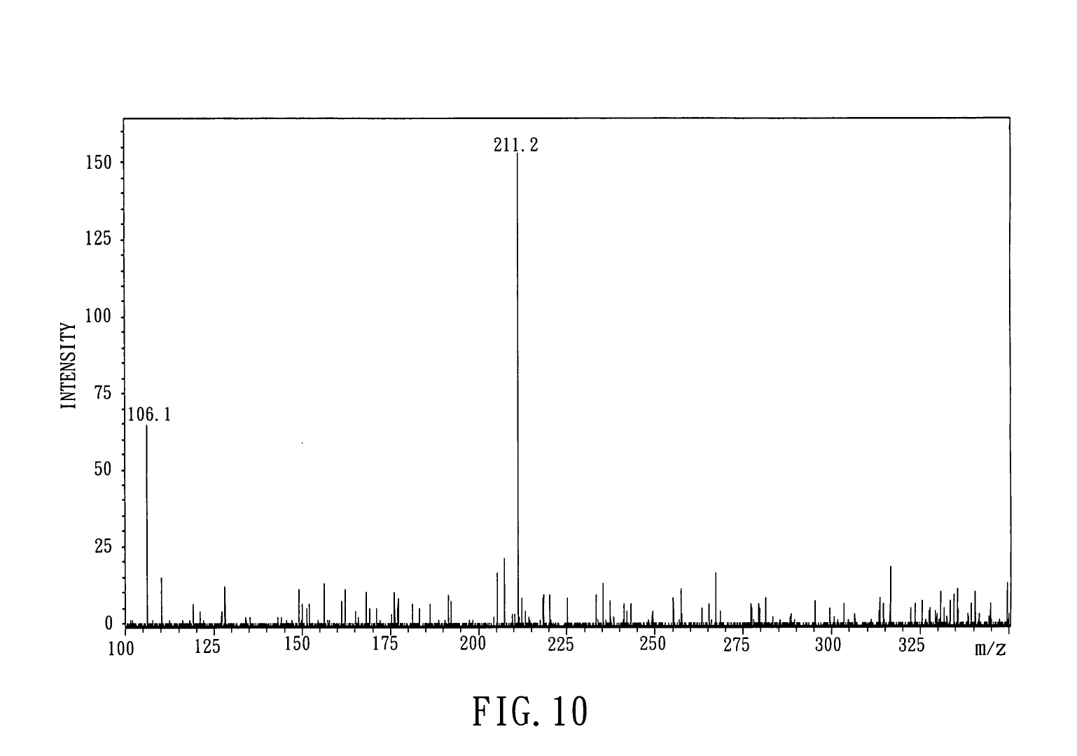

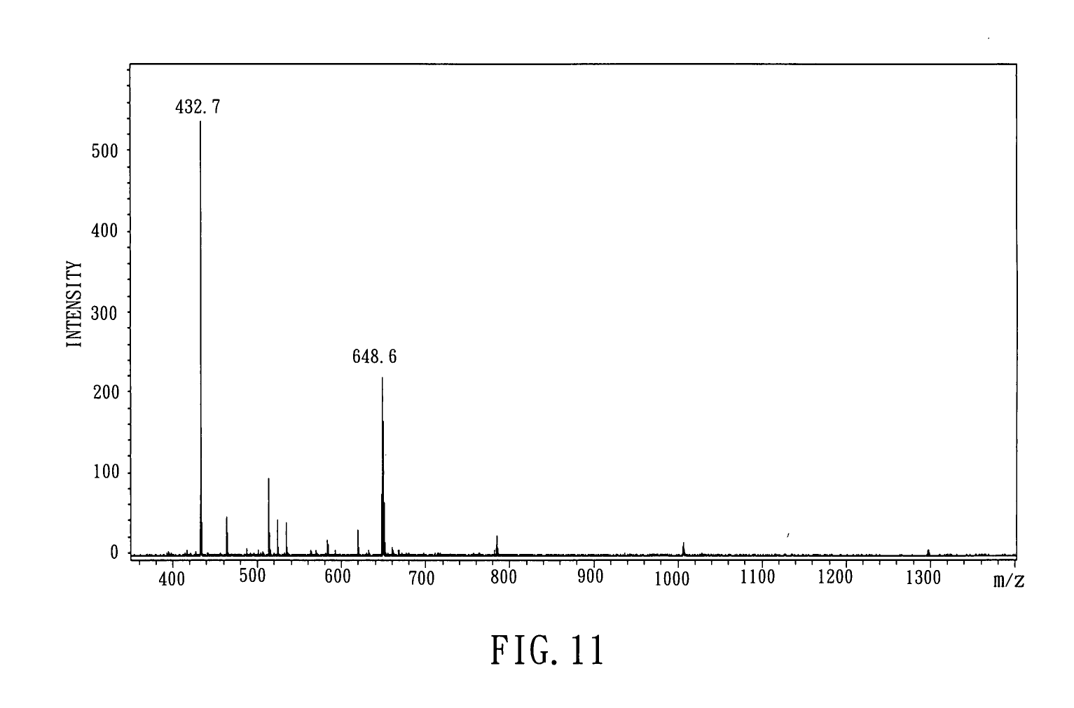

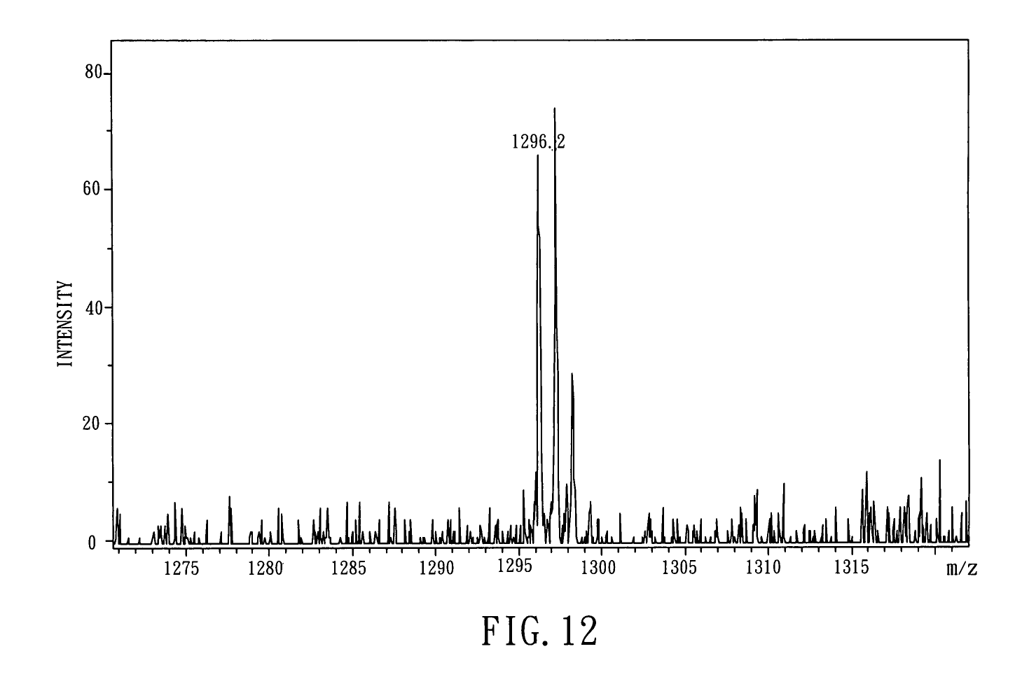

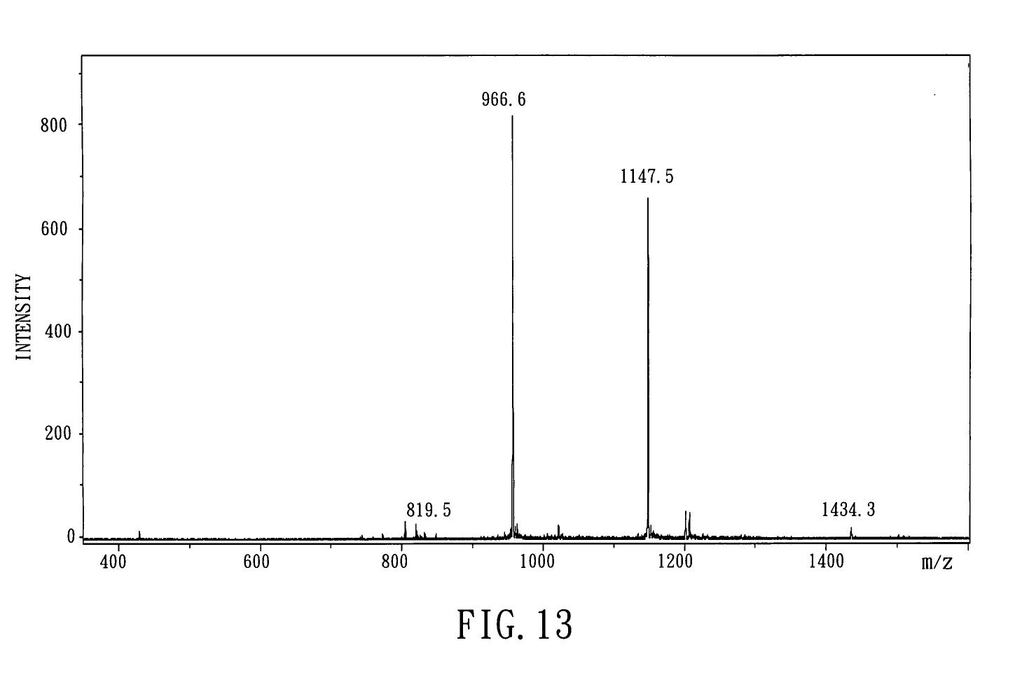

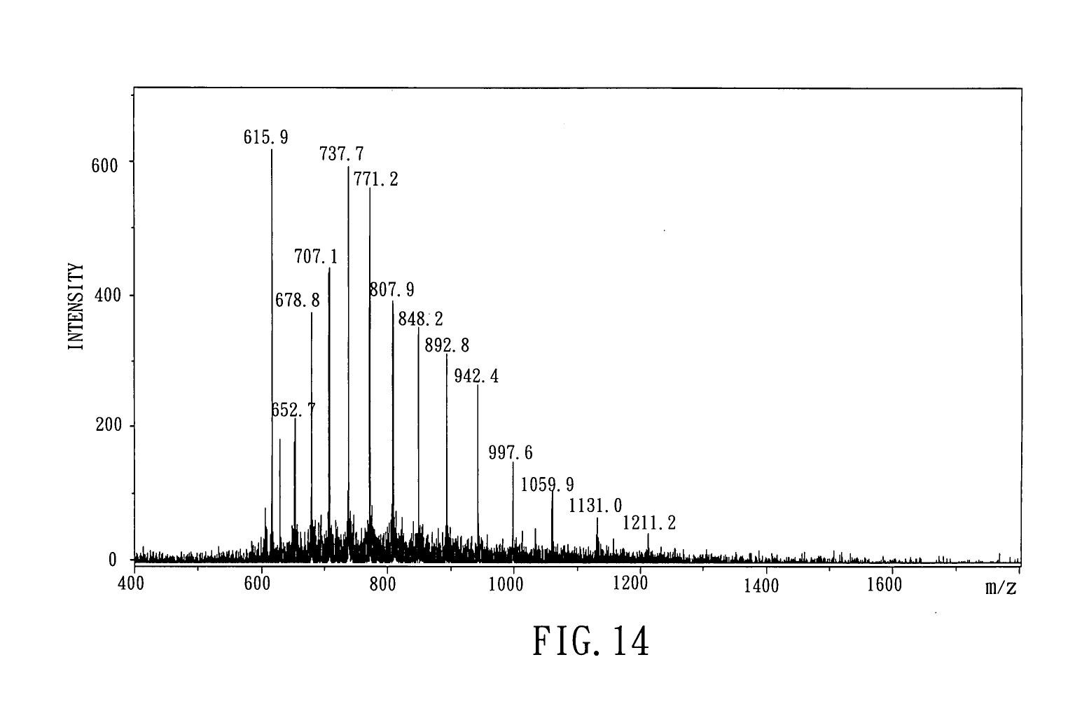

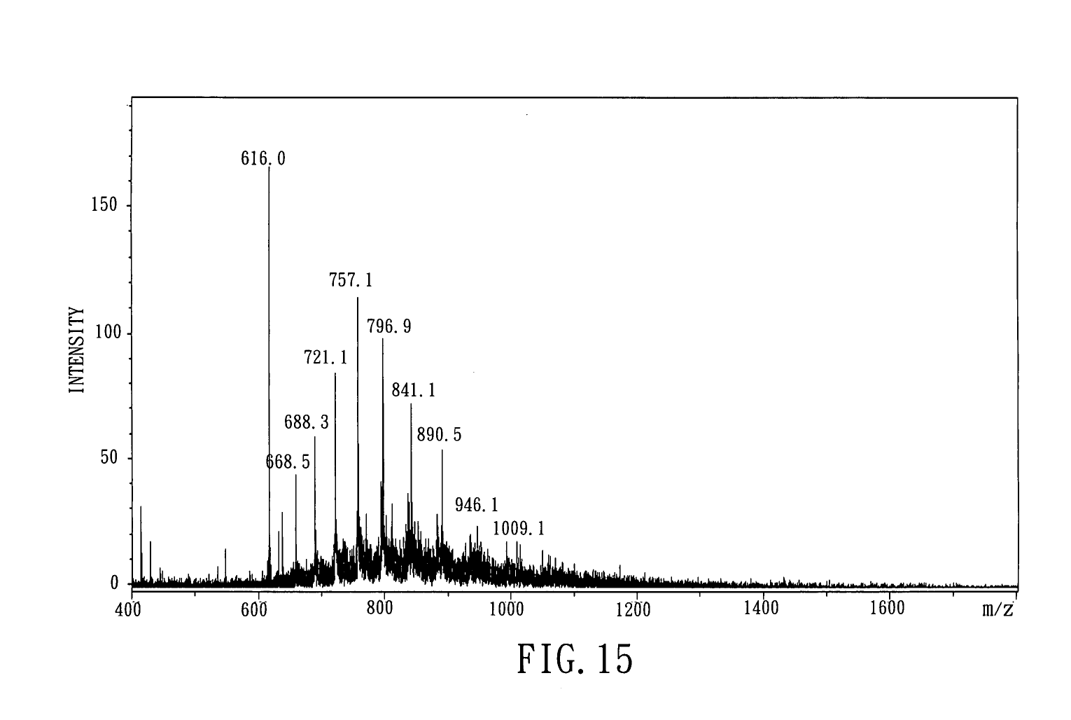

TABLE 2

| | | | | | Mass spectrum |
|---|---|---|---|---|---|
| | | | Estimated mass | | signal (m/z) |
| | | Type of | spectrum signal | | (value of ‘n’ |
| | | protein or | (m/z) | Mass | of the ionized |
| Experiment | Laser energy | amino acid (m) | [(m + n)/n] | Spectrum | analyte) |
| 2 | 18 mJ | Methionine | 150.21 (n = 1) | FIG. 5 | 150.1, |
| | | (149.21) | 299.42 | | 299.2 (n = 1) |
| | | | (dimer; n = 1) | | |
| 3 | 18 mJ | Histidine | 156.16(n = 1) | FIG. 6 | 156.1 |
| | | (155.16) | | | |
| 4 | 18 mJ | Cystine | 122.16 (n = 1) | FIG. 7 | 122.1 |
| | | (121.16) | | | |
| 5 | 18 mJ | Asparaginase | 133.12 (n = 1) | FIG. 8 | 133.1, 265.2 |
| | | (132.12) | 265.24 (dimer; | | |
| | | | n = 1) | | |
| 6 | 18 mJ | Lysine | 147.19 (n = 1) | FIG. 9 | 147.2, 293.3 |
| | | (146.19) | 293.38 (dimer; | | |
| | | | n = 1) | | |
| 7 | 18 mJ | Serine | 106.09 (n = 1) | FIG. 10 | 106.1, 211.2 |
| | | (105.09) | 211.18 (dimer; | | |
| | | | n = 1) | | |
| 8 | 18 mJ | Angiotensin I | 432.7 (n = 3) | FIG. 11 | 432.7, 648.6 |
| | | (1296.48) | 648.6 (n = 2) | | |
| | 18 mJ | | 1296.2 (n = 1) | FIG. 12 | 1296.2 |
| 9 | 18 mJ | Insulin | 820.1 (n = 7) | FIG. 13 | 819.5, 956.6, |
| | | (5733.49) | 956.6 (n = 6) | | 1147.5 |
| | | | 1147.7 (n = 5) | | |
| 10 | 18 mJ | Myoglobin | (16950 + n)/n | FIG. 14 | 615.9, |
| | | (16950) | 616.0 | | 652.7 (n = 26), |
| | | | | | 678.8 (n = 25), |
| | | | | | 707.1 (n = 24), |
| | | | | | 737.7 (n = 23), |
| | | | | | 771.2 (n = 22), |
| | | | | | 807.9 (n = 21), |
| | | | | | 848.2 (n = 20), |
| | | | | | 892.8 (n = 19), |
| | | | | | 942.4 (n = 18), |
| | | | | | 997.6 (n = 17), |
| | | | | | 1059.9 (n = 16), |
| | | | | | 1131.0 (n = 15), |
| | | | | | 1211.2 (n = 14) |
| 11 | 18 mJ | Hemoglobin | (15120 + n)/n | FIG. 15 | 616.0, |
| | | (15120) | 616.0 | | 658.5 (n = 23), |
| | | | | | 688.3 (n = 22), |
| | | | | | 721.1 (n = 21), |
| | | | | | 757.1 (n = 20), |
| | | | | | 796.9 (n = 19), |
| | | | | | 841.1 (n = 18), |
| | | | | | 890.5 (n = 17), |
| | | | | | 946.1 (n = 16), |
| | | | | | 1009.1 (n = 15) |

In experiments 2 to 11, for each of the detected mass spectrum signals, a reasonable value of ‘n’ can be calculated from the m/z value and the corresponding molecular weight of the sample used. This verities that under the positive ion mode, the method for mass spectrometry according to the present invention is applicable for conducting mass spectrometric analysis on dehydrated samples obtained from various amino acid solutions and protein solutions, and that the results obtained therefrom are indeed reliable.

Experiments 12˜18—Mass Spectrometric Analysis Conducted on Solid Samples under Negative Ion Mode

In experiments 12 to 18, dehydrated samples obtained from standard amino acid solutions (with a concentration of 10⁴M) were respectively used. However, different from experiments 2 to 11, the negative ion mode for the electrospray process was used for experiments 12 to 18. Since in one instance, liquid portion of a negatively-charged droplet vaporizes to thereby cause the electrons of the negatively-charged droplet to be attached to the desorbed analytes so as to form negatively charged ionized analytes, and since in another instance, the negatively charged liquid drop undergoes ion/molecule association reactions with the desorbed analytes so as to generate negatively charged ionized analytes, the estimated mass spectrum signals have m/z values of [(m−1)/1], where ‘m’ is the molecular weight of the amino acid. Moreover, the presence of a mass spectrum signal having m/z values of (2m−1) indicates that the analyte is in the form of a dimer, and is a normal phenomenon.

The laser energy used, the types of amino acid, the estimated mass spectrum signals, the figure numbers of the obtained mass spectra, and the detected signals in the obtained mass spectra for experiments 12 to 18 are tabulated in Table 3 below.

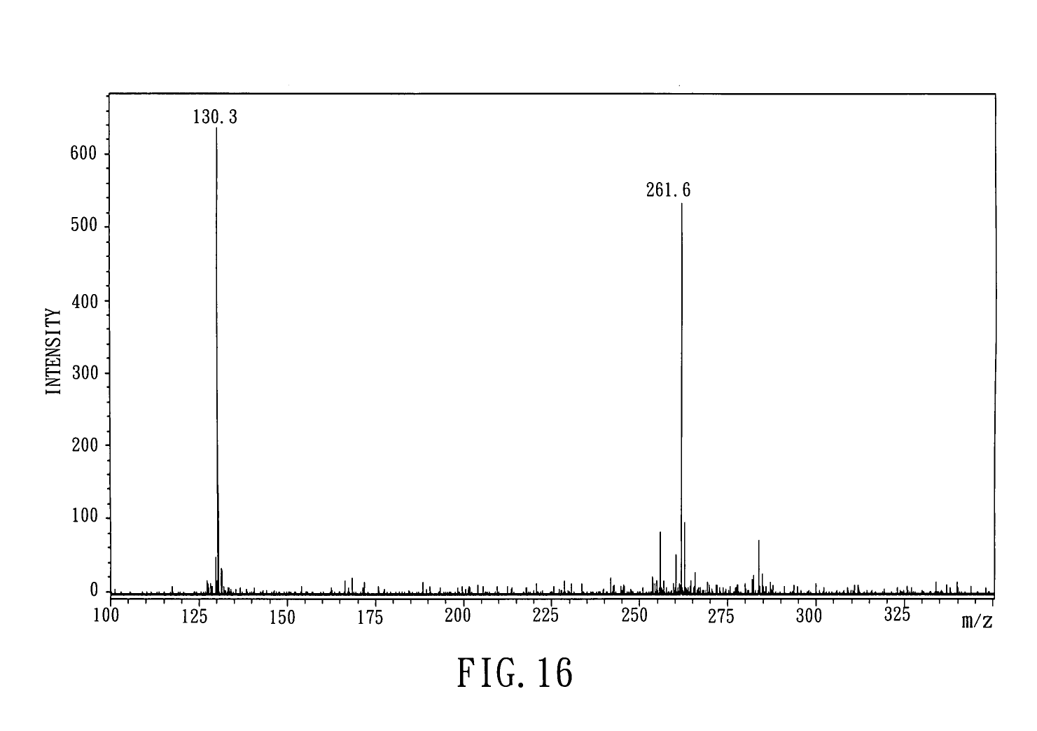

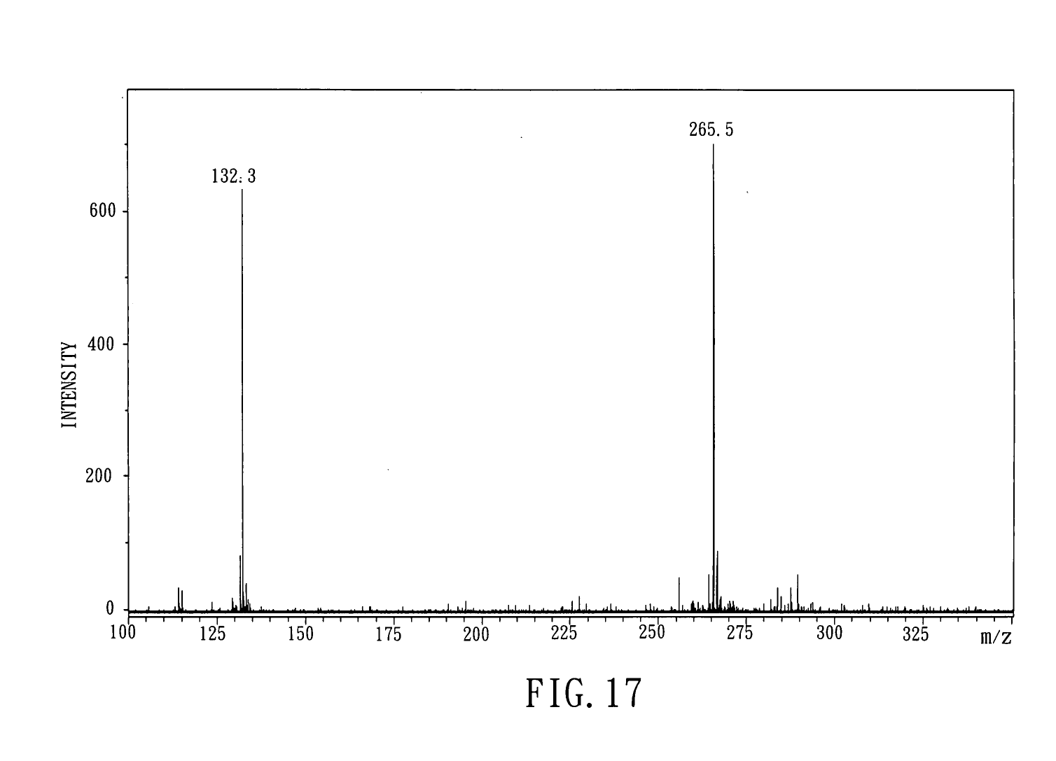

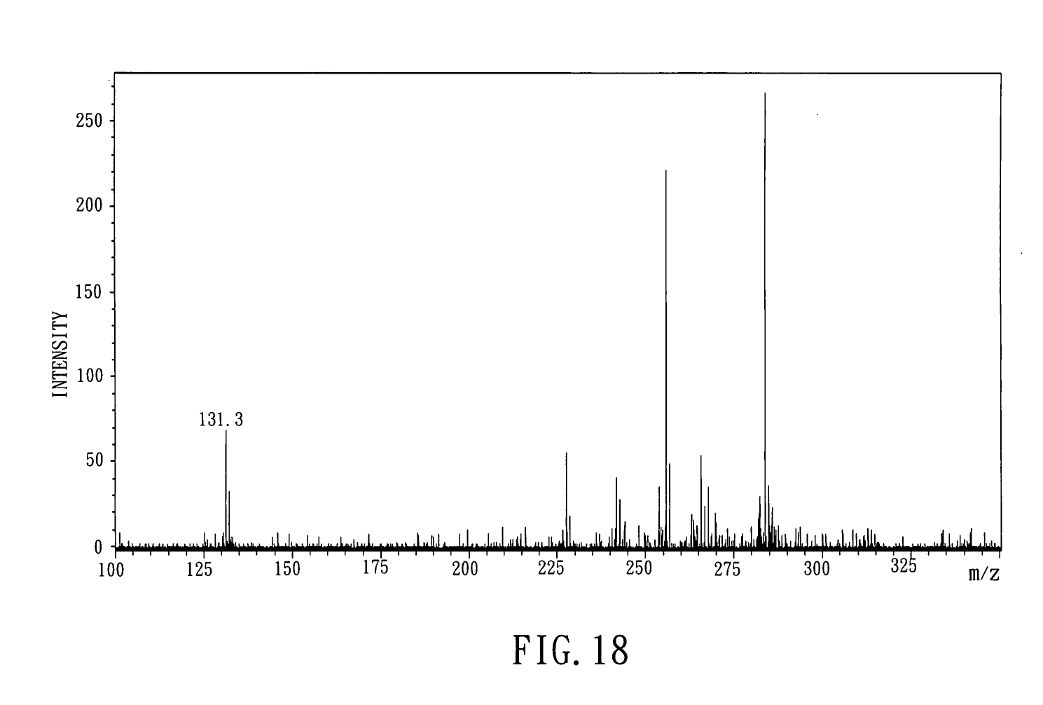

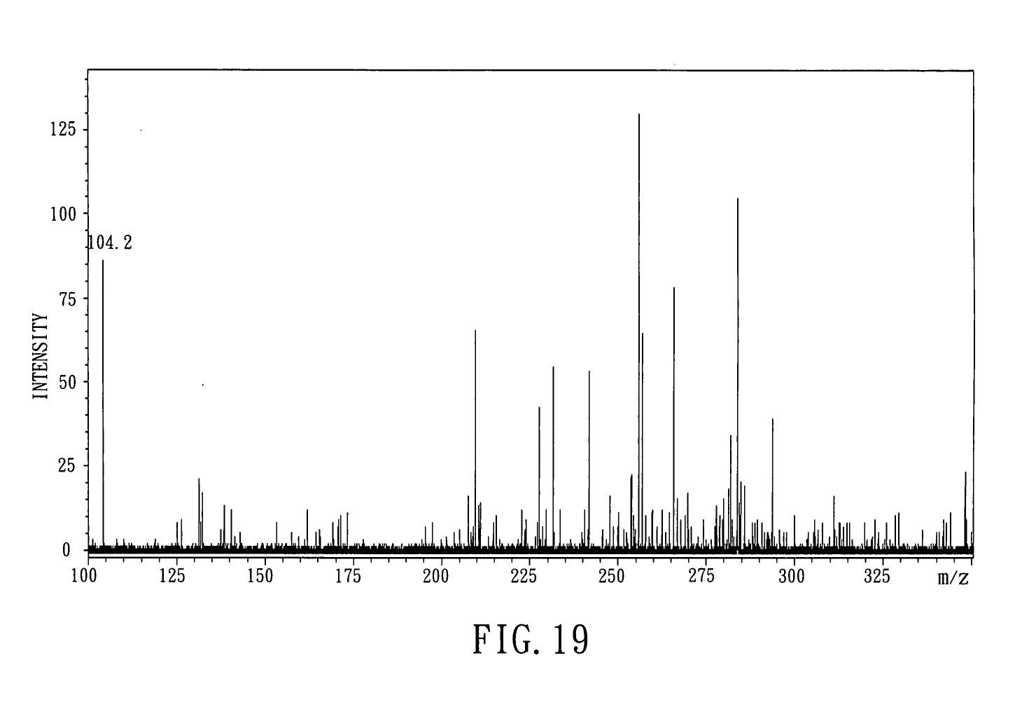

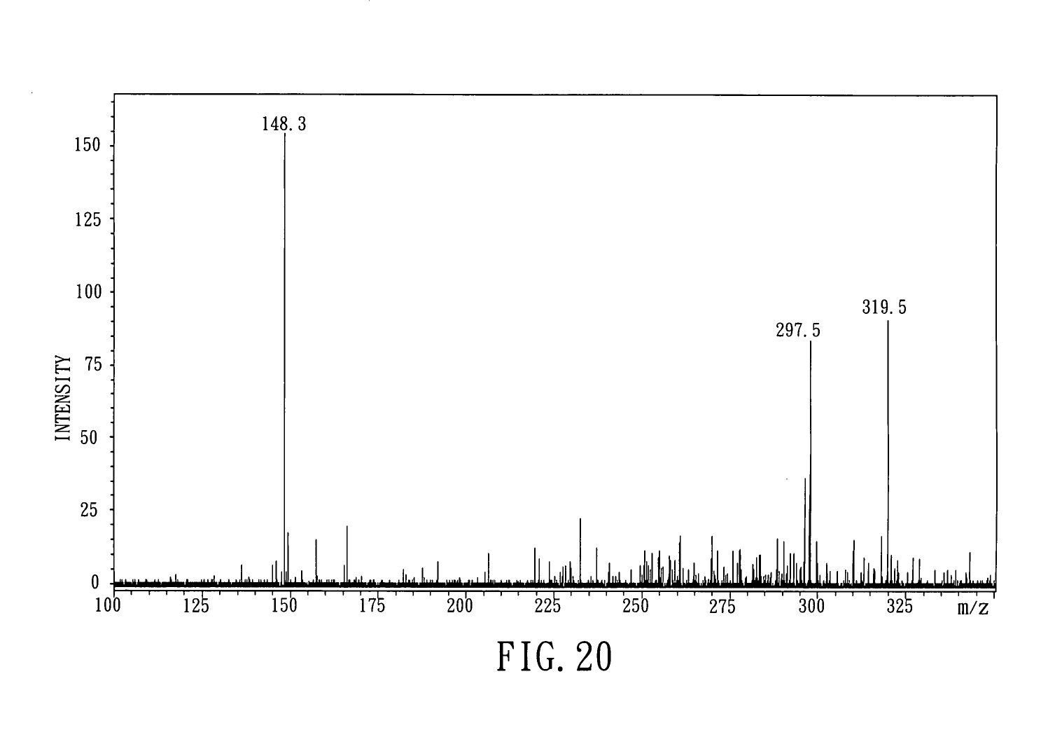

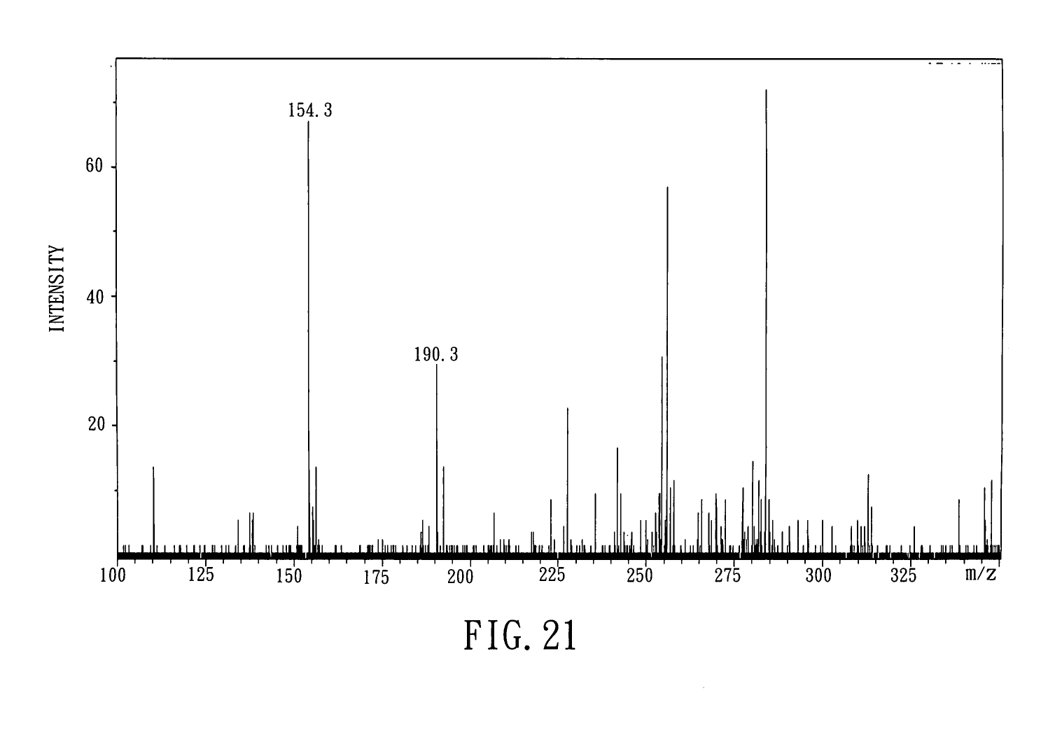

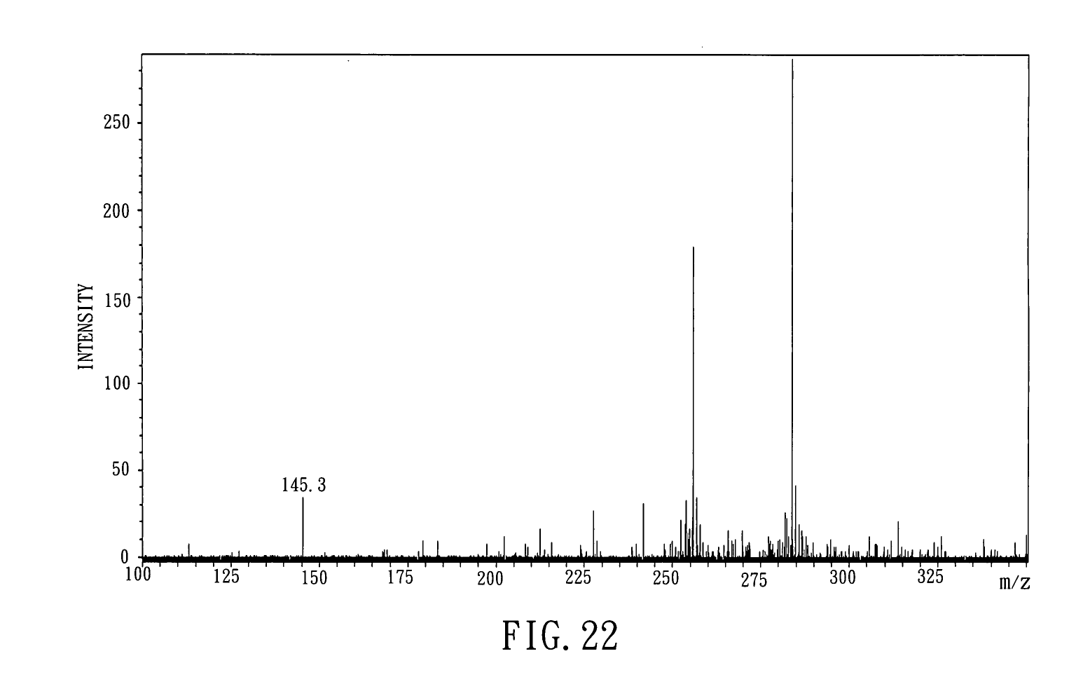

TABLE 3

| | | | Estimated mass | | |
|---|---|---|---|---|---|
| | | Type of amino | spectrum signal | | |
| | | acid | (m/z) | Mass | Mass spectrum |
| Experiment | Laser energy | (m) | (m − 1) | Spectrum | signal (m/z) |
| 12 | 18 mJ | Leucine | 130.1 | FIG. 16 | 130.3, 261.6 |
| | | (149.21) | 261.34 (dimer) | | |
| 13 | 18 mJ | Aspartase | 132.1 | FIG. 17 | 132.3, 265.5 |
| | | (155.16) | 265.2 (dimer) | | |
| 14 | 18 mJ | Asparaginase | 131.1 | FIG. 18 | 131.3 |
| | | (121.16) | | | |
| 15 | 18 mJ | Serine | 104.09 | FIG. 19 | 104.2 |
| | | (132.12) | | | |
| 16 | 18 mJ | Methionine | 148.21 | FIG. 20 | 148.3, 297.5 |
| | | (146.19) | 297.42 (dimer) | | |
| 17 | 18 mJ | Histidine | 154.16 | FIG. 21 | 154.3 |
| | | (105.09) | | | |
| 18 | 18 mJ | Lysine | 145.19 | FIG. 22 | 145.3 |
| | 18 mJ | (1296.48) | | | |

In each of experiments 12 to 18, the detected mass spectrum signals respectively correspond to corresponding ones of the estimated mass spectrum signals. Consequently, the method for mass spectrometry according to the present invention is verified to be capable of conducting mass spectrometric analysis on dehydrated samples obtained from various amino acid solutions under the negative ion mode, and it is also evident that the results obtained therefrom are indeed reliable.

Experiments 19˜22—Mass Spectrometric Analysis Conducted on Solution Samples under Positive Ion Mode

In experiments 19 to 22, various standard protein solutions having a concentration of 10⁻⁴M mixed with glycerin were respectively used, where the glycerin was added to prevent the standard protein solutions from dehydration. The laser energy used, the types of protein (or amino acid), the estimated mass spectrum signals, the figure numbers of the obtained mass spectra, and the detected signals in the obtained mass spectra for experiments 19 to 22 are tabulated in Table 4 below.

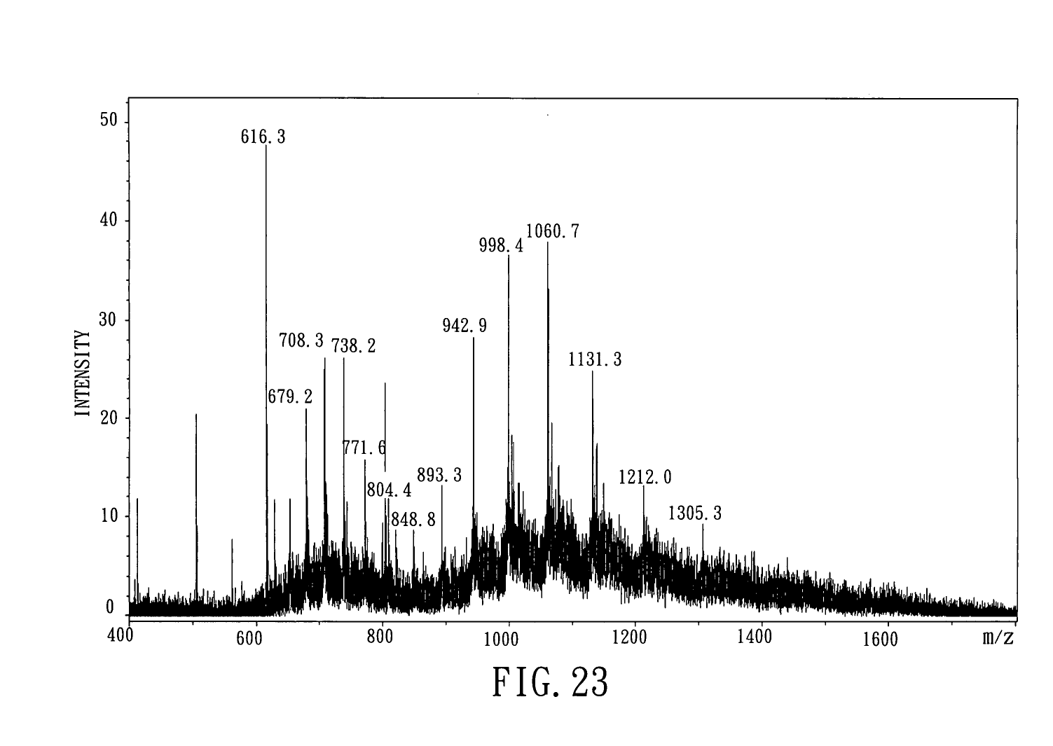

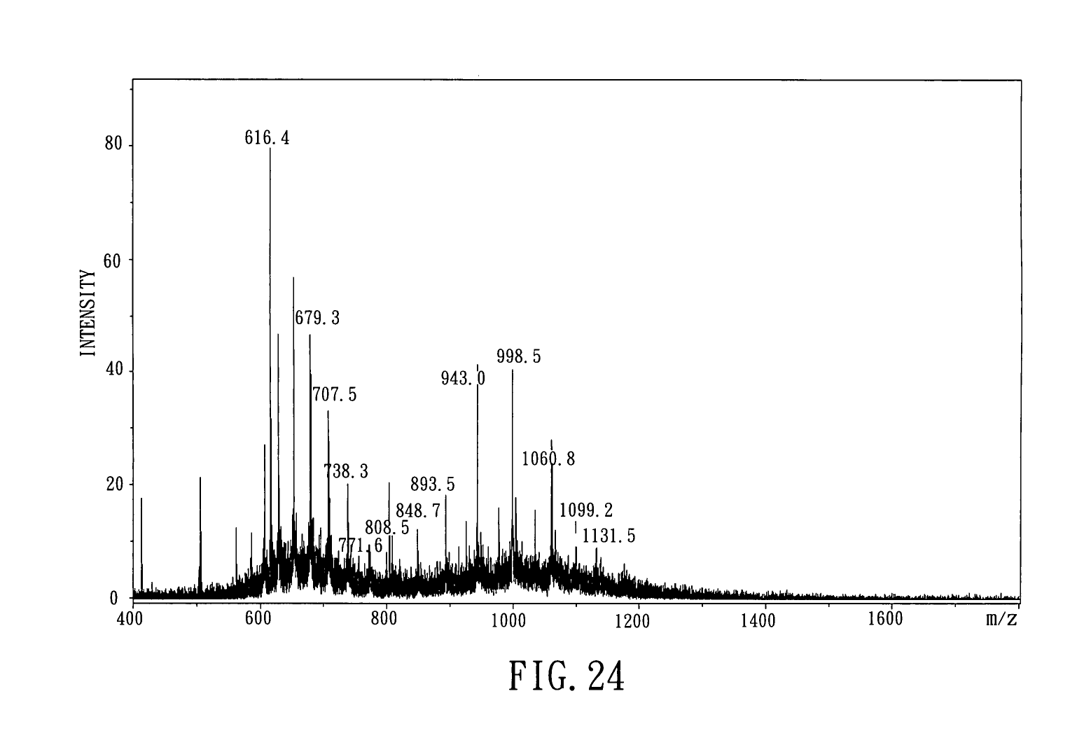

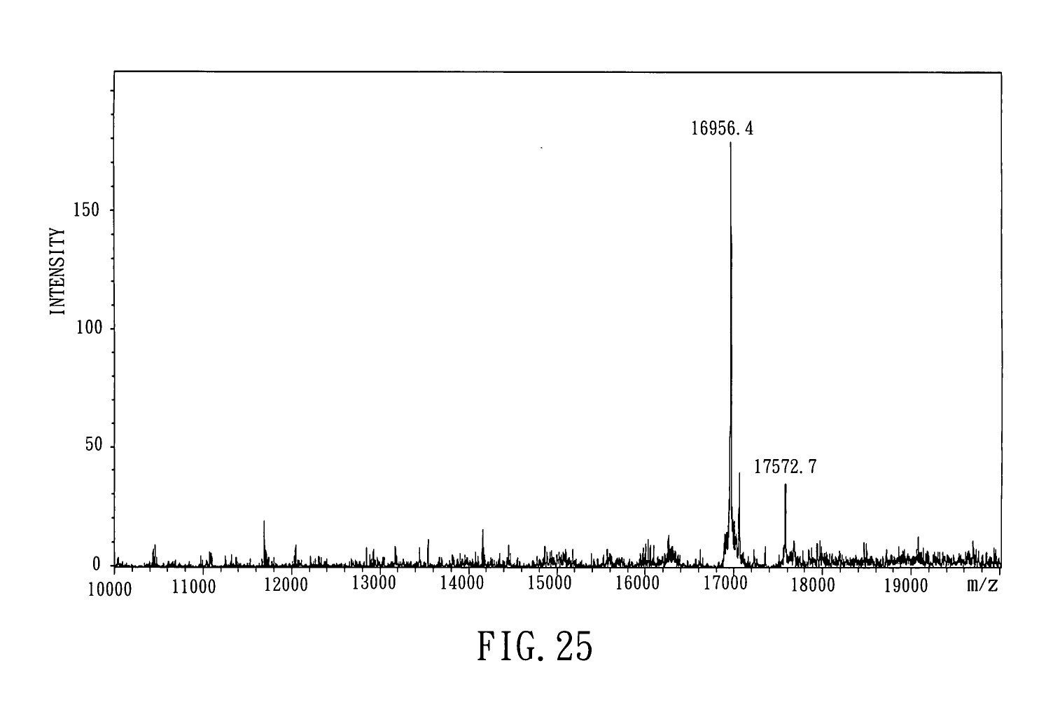

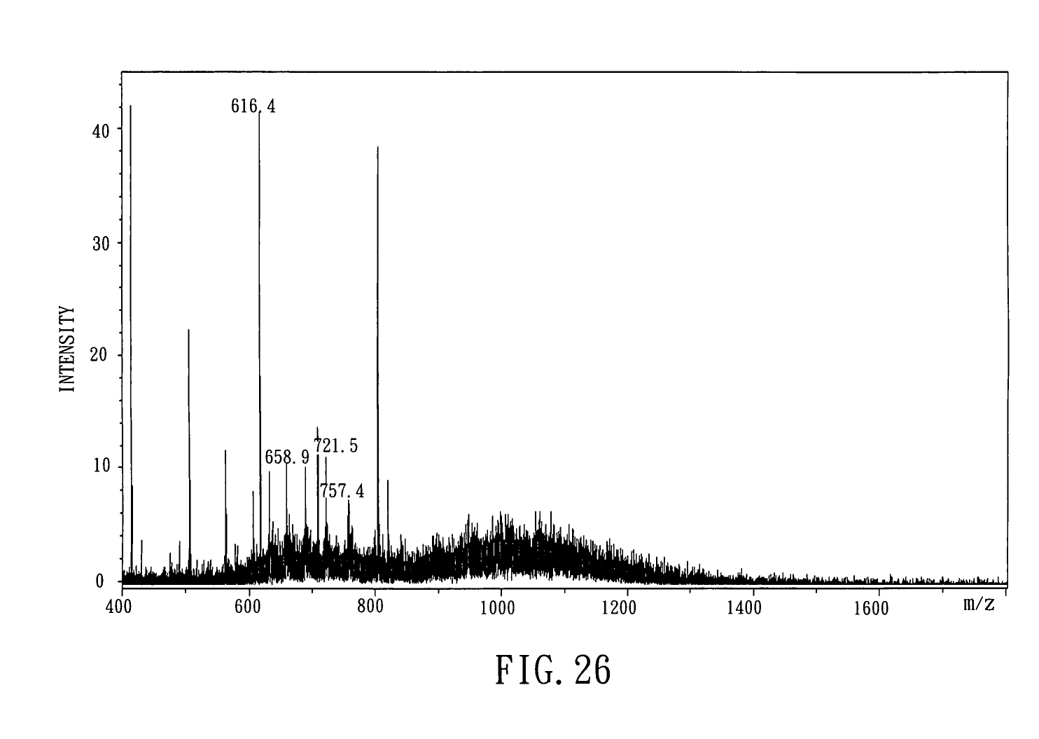

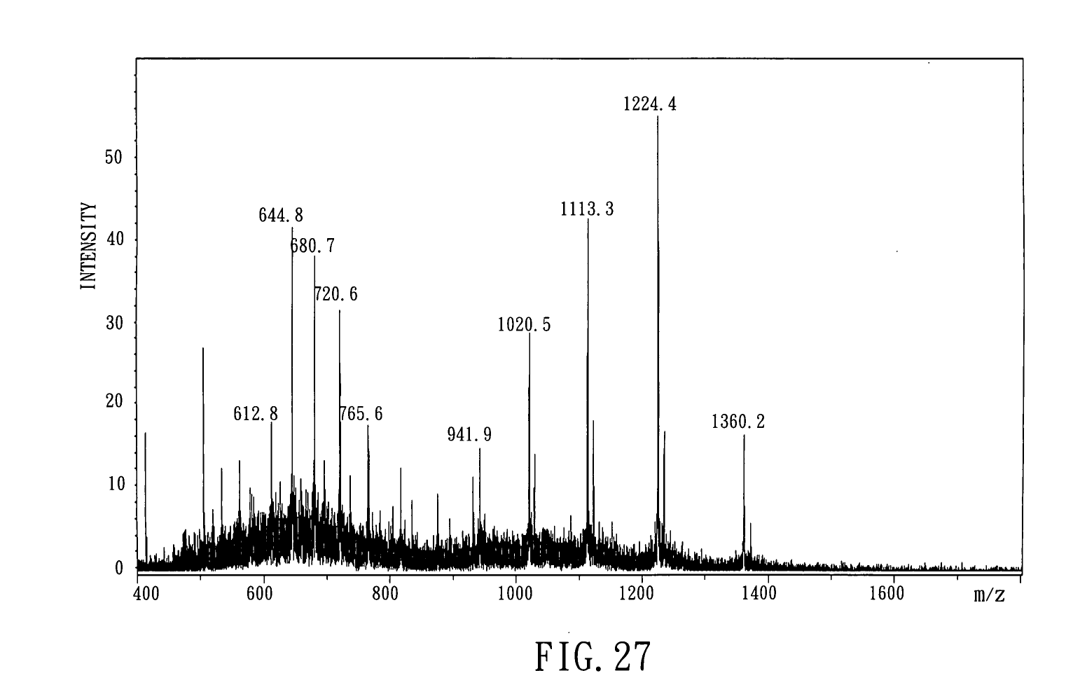

TABLE 4

| | | | | Estimated | | |
|---|---|---|---|---|---|---|
| | | | | mass | | |
| | | | | spectrum | | |
| | | Type of | | signal | | |
| | Laser | protein | Glycerin | (m/z) | Mass | Mass spectrum |
| Experiment | energy | (m) | concentration | [m − 1] | Spectrum | signal (m/z) |
| 19 | 39 mJ | Myoglobin | 5% | (16950 + n)/n | FIG. 23 | 616.3, |
| | | (16950) | | 616.0 | | 679.3 (n = 25), |
| | | | | | | 708.3 (n = 24), |
| | | | | | | 738.2 (n = 23), |
| | | | | | | 771.6 (n = 22), |
| | | | | | | 808.4 (n = 21), |
| | | | | | | 848.8 (n = 20), |
| | | | | | | 893.3 (n = 19), |
| | | | | | | 942.9 (n = 18), |
| | | | | | | 998.4 (n = 17), |
| | | | | | | 1060.7 (n = 16), |
| | | | | | | 1131.3 (n = 15), |
| | | | | | | 1212.0 (n = 14), |
| | | | | | | 1305.3 (n = 13) |
| 20 | 39 mJ | Myoglobin | 10% | (16950 + n)/n | FIG. 24 | 616.4, |
| | | (16950) | | 616.0 | | 679.3 (n = 25), |
| | | | | | | 707.5 (n = 24), |
| | | | | | | 738.3 (n = 23), |
| | | | | | | 771.6 (n = 22), |
| | | | | | | 808.5 (n = 21), |
| | | | | | | 848.7 (n = 20), |
| | | | | | | 893.5 (n = 19), |
| | | | | | | 943.0 (n = 18), |
| | | | | | | 998.5 (n = 17), |
| | | | | | | 1060.8 (n = 16), |
| | | | | | | 1099.2 (n = 16, |
| | | | | | | including |
| | | | | | | hematin), |
| | | | | | | 1131.5(n = 15) |
| | | | | | FIG. 25 | 16956.4, |
| | | | | | | 17572.7 |
| 21 | 39 mJ | Hemoglobin | 5% | (15120 + n)/n | FIG. 26 | 616.4, |
| | | (15120) | | 616.0 | | 658.9 (n = 23), |
| | | | | | | 721.5 (n = 21), |
| | | | | | | 757.4 (n = 20) |
| 22 | 39 mJ | Cytochrome c | 5% | (12230 + n)/n | FIG. 27 | 612.8 (n = 20), |
| | | (12230) | | | | 644.8 (n = 19), |
| | | | | | | 680.7 (n = 18), |
| | | | | | | 720.6 (n = 17), |
| | | | | | | 765.6 (n = 16), |
| | | | | | | 941.9 (n = 13), |
| | | | | | | 1020.5 (n = 12), |
| | | | | | | 1113.3 (n = 11), |
| | | | | | | 1224.4 (n = 10), |
| | | | | | | 1360.2 (n = 9) |

In experiment 19 to 22, for each of the detected mass spectrum signals, a reasonable value of ‘n’ can be calculated from the m/z value and the corresponding molecular weight of the protein sample used, indicating that when using the method for mass spectrometry according to the present invention to conduct mass spectrometric analysis on protein solutions, the resultant mass spectrum matches estimation. Therefore, the method for mass spectrometry according to the present invention is capable of conducting mass spectrometric analysis on liquid samples, and the results obtained therefrom are indeed reliable.

Furthermore, it is observed that the mass spectra obtained for experiment 10 (FIG. 14, with dehydrated sample obtained from 10⁻⁴M myoglobin solution) and for experiments 19 and 20 (FIG. 23 and FIG. 24, respectively, with 10⁻⁴M myoglobin solution sample), the mass spectrum signals (m/z values) are almost identical, indicating that the detected analytes are identical in these experiments.

It is evident that, when taken the mass spectrum signal formed by hematin (i.e., m/z value of 616.0) out of consideration, the mass spectrum illustrated in FIG. 14 is basically composed of an ion peak group having m/z values that range from 652.7 to 1211.2, while each of the mass spectra illustrated in FIG. 23 and FIG. 24 is basically composed of two ion peaks groups respectively having m/z values of smaller than 808.4 (or 808.5) and of greater than 893.4. This difference is caused by denaturing of myoglobin during dehydration in experiment 10, where denatured myoglobin molecules have a linear chain geometry with a greater surface area and prone to be bonded to a plurality of protons (H*), resulting in a greater number of multivalent ionized analytes, and in turn a greater intensity for signals having smaller m/z values.

FIG. 25 is a deconvoluted mass spectrum of FIG. 24. From FIG. 25, it can be seen that the mass spectrum of FIG. 24 is composed of denatured myoglobin (corresponding to a m/z value of 16956.4) and un-denatured myoglobin combined with hematin (corresponding to a m/z value of 17572.7). In addition, since the analytes in experiments 19 and 20 were desorbed from myoglobin solutions, as compared to experiment 10, more native (un-denatured) myoglobin molecules should be detected. Moreover, since native myoglobin molecules have a globular structure with a smaller surface area and have a tendency to be bonded to a smaller number of protons (H⁺). As a result, percentage of total intensity of signals having m/z values greater than 893 with respect to total intensity of all signals in the mass spectrum is greater in FIG. 23 and FIG. 24 than in FIG. 14.

Similarly, analysis results of experiment 1 (FIG. 4, with dehydrated sample obtained from 10⁻⁴M cytochrome c solution) and experiment 22 (FIG. 27, with 10⁻⁴M cytochrome c solution sample) are similar to each other. Consequently, it has been verified that the form that the sample takes does not affect the accuracy of analysis of the method for mass spectrometry according to the present invention.

Exemplary Applications 1˜7—Mass Spectrometric Analysis Conducted on Dehydrated Samples obtained from Various Solutions under Positive Ion Mode

In exemplary applications 1 to 7, dehydrated samples obtained from various solutions were used. The particular solutions, the figure numbers of the obtained mass spectra, and the detected signals are tabulated in Table 5 that follows.

In particular, the effective ingredient in Viagra, Sildenafil, has a molecular weight of 474.58. Therefore, it was estimated that a signal having a m/z value of approximately 475.6 be generated. In addition, since rhodamine, which has a molecular weight of 445, is a common ingredient in red ink, it was estimated that a signal having a m/z value of approximately 443 be generated. Furthermore, since milk contains an abundance of protein and lipid, it was estimated that signals corresponding thereto be generated. However, since the samples used in exemplary applications 5 to 7 were dehydrated samples obtained from milk, it was estimated that there is a greater possibility of detecting lipid than detecting protein since there would be a greater distribution of lipid on the surface of the dehydrated samples.

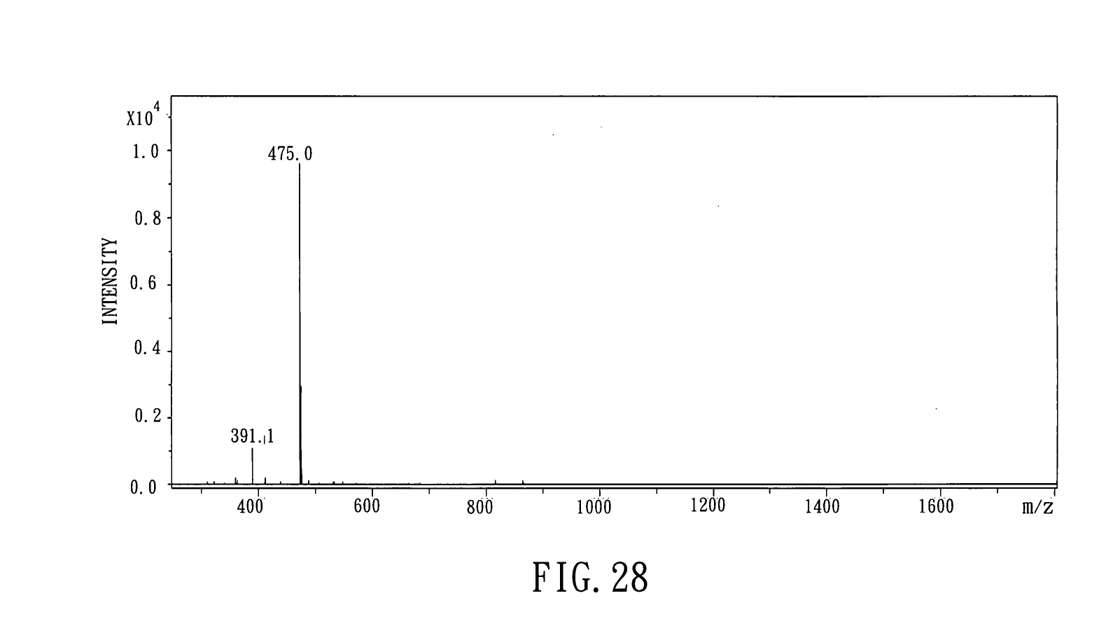

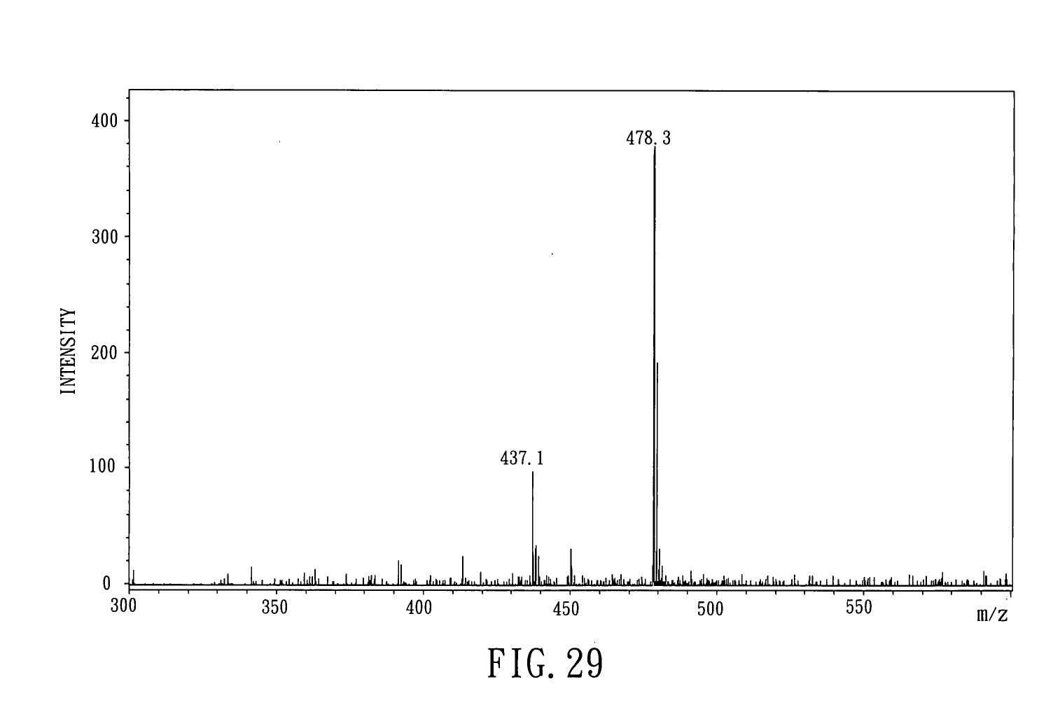

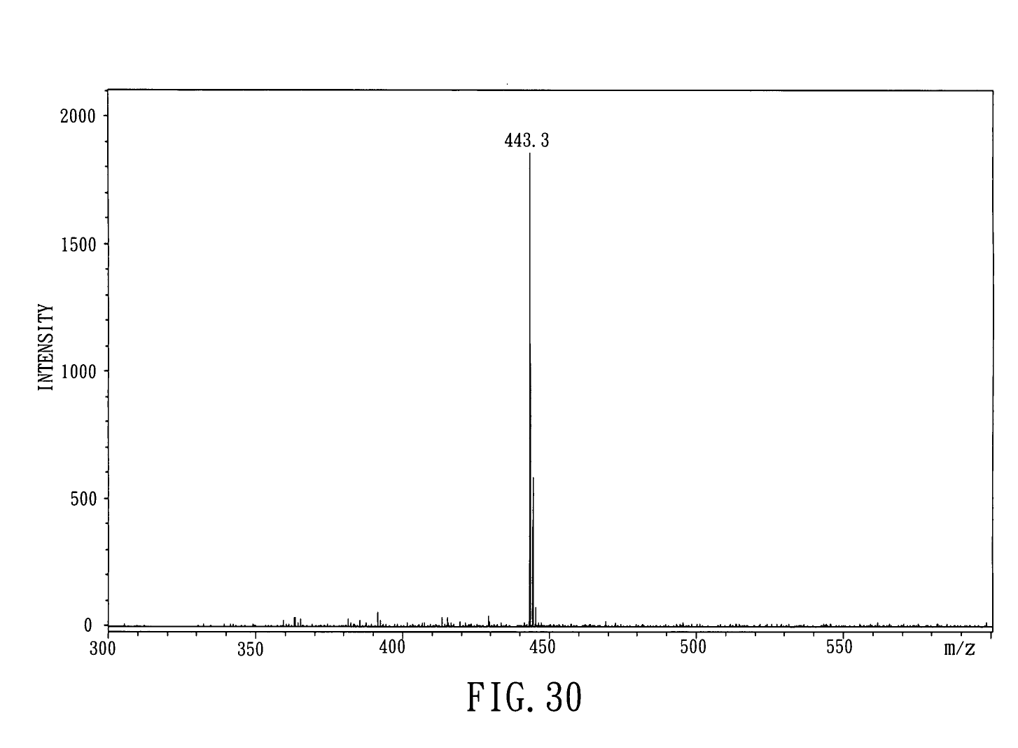

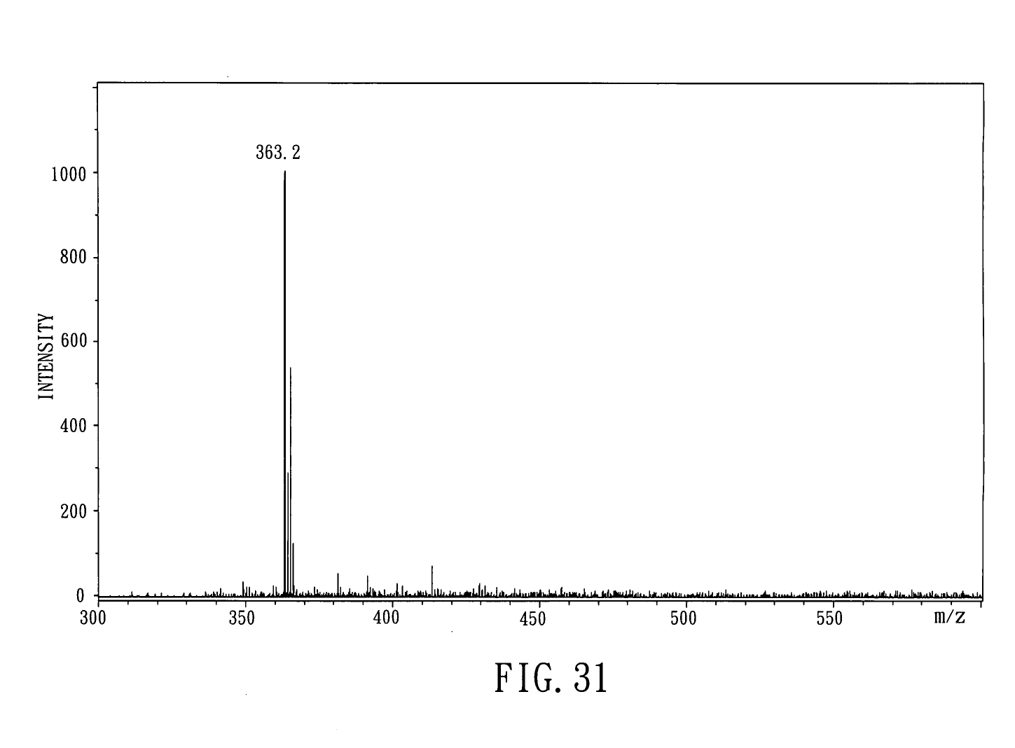

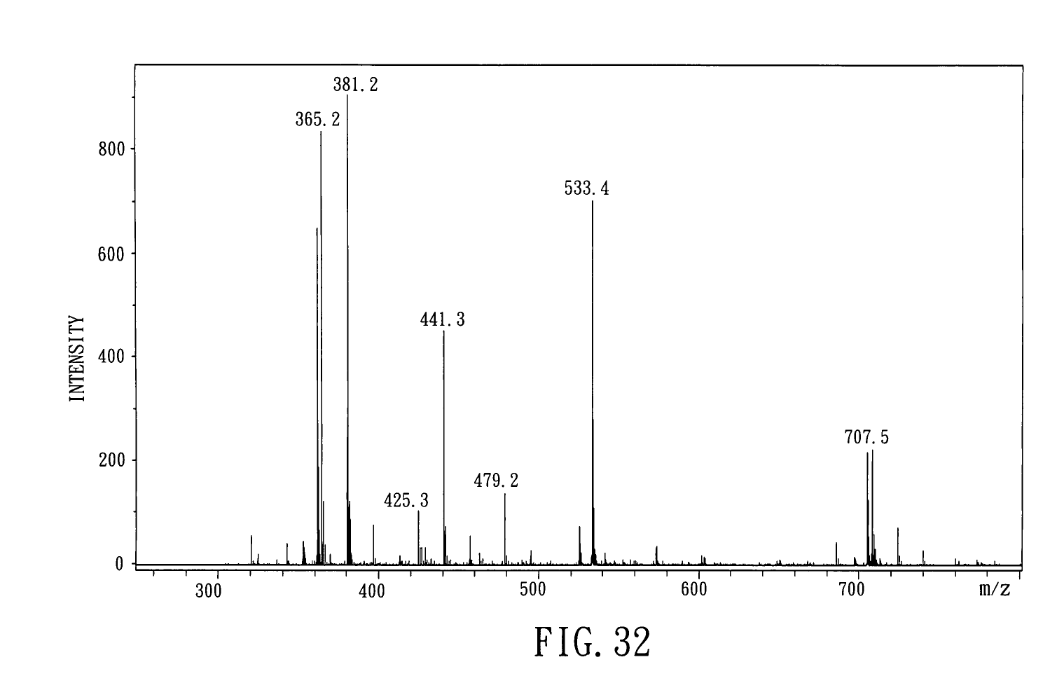

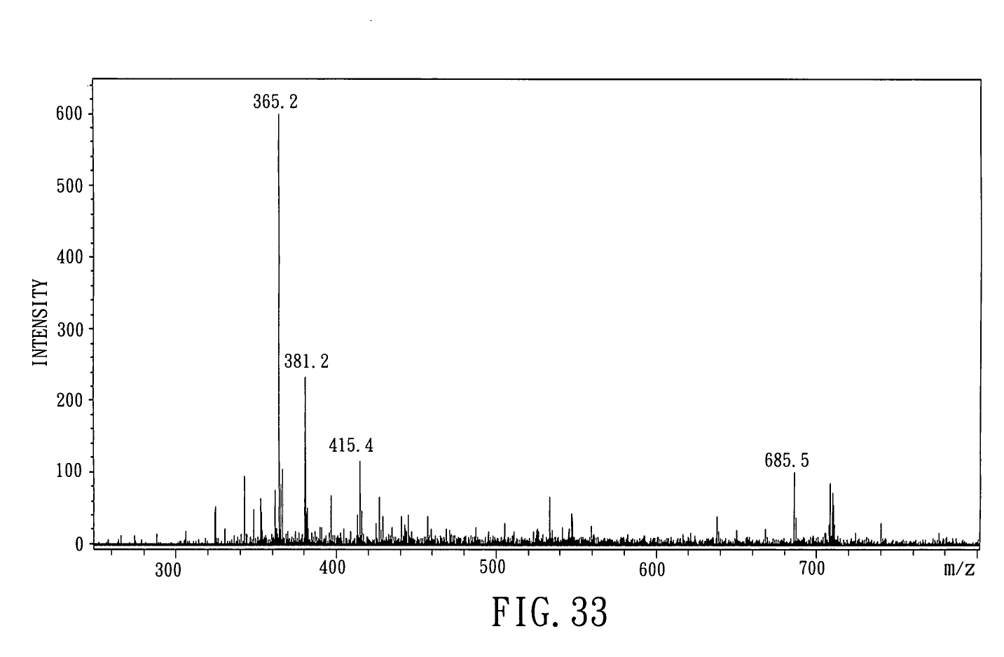

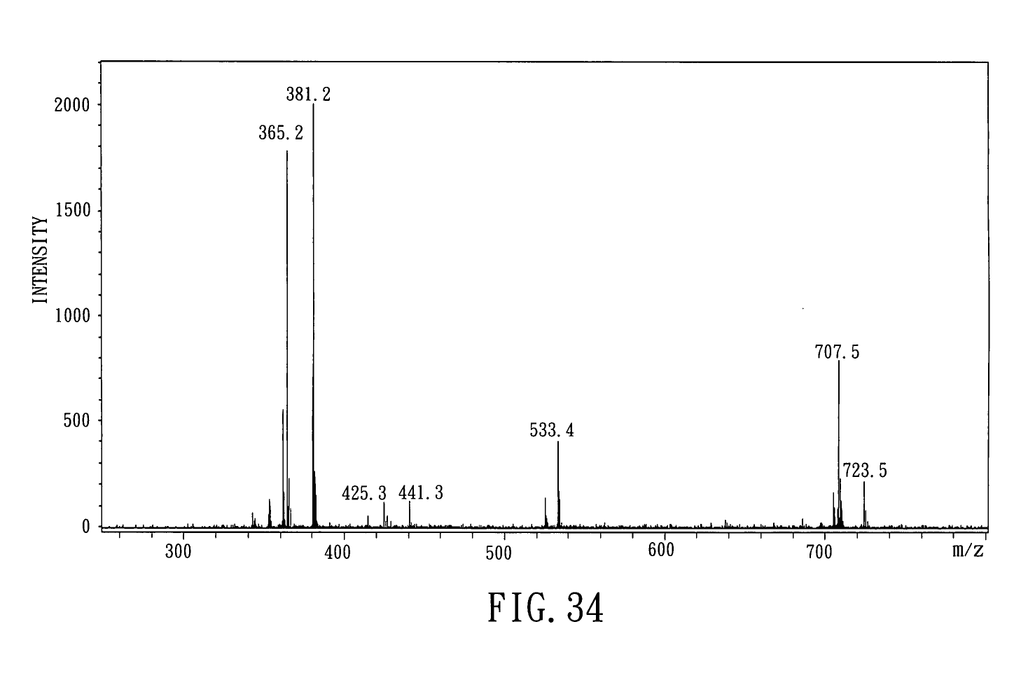

TABLE 5

| | Application | | | | | | |
|---|---|---|---|---|---|---|---|
| | 1 | 2 | 3 | 4 | 5 | 6 | 7 |
| | Particular solution | | | | | | |
| | | | | | | Fat | |
| | Viagra | Marker ink | | | Pasteurized | free | Whole |
| | solution | green | red | blue | milk | milk | milk |
| Laser | 18 mJ | 18 mJ | 18 mJ | 18 mJ | 35 mJ | 35 mJ | 35 mJ |
| energy | | | | | | | |
| Mass | FIG. 28 | FIG. 29 | FIG. 30 | FIG. 31 | FIG. 32 | FIG. 33 | FIG. 34 |
| spectrum | | | | | | | |
| Detected | 391.1 | 437.1 | 443.3 | 363.2 | 365.2 | 365.2 | 365.2 |
| signals | 475.0 | 478.3 | | | 381.2 | 381.2 | 381.2 |
| (m/z) | | | | | 425.3 | 415.4 | 425.3 |
| | | | | | 441.3 | 685.5 | 441.3 |
| | | | | | 479.2 | | 533.4 |
| | | | | | 533.4 | | 707.5 |
| | | | | | 707.5 | | 723.5 |

With reference to the results tabulated in Table 5, a signal corresponding to Sildenafil was indeed detected in exemplary application 1, and a signal corresponding to rhodamine was indeed generated exemplary application 3. In addition, since the signal corresponding to rhodamine is absent in both the results obtained for both exemplary application 2 and exemplary application 3, it was inferred that the green and blue marker ink does not contain rhodamine. It is speculated that the signals detected in exemplary applications 2 and 3 come from green and blue dyes. Furthermore, the signals detected in exemplary applications 5 to 7 mainly came from lipid.

Exemplary Application 8—Mass Spectrometric Analysis Conducted on Milk under Positive Ion Mode

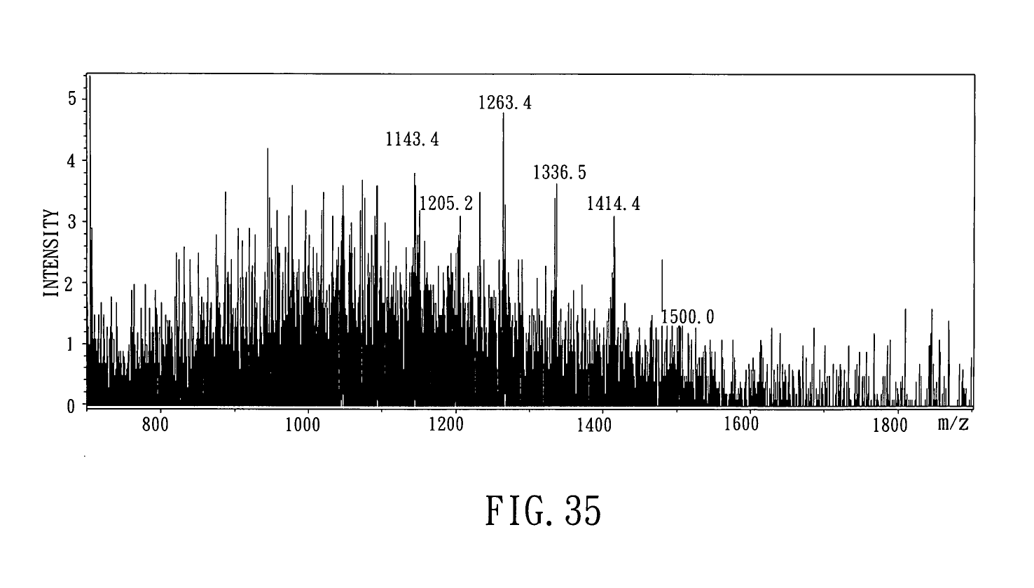

In exemplary application 8, milk (non-dehydrated) was used directly as the sample for conducting mass spectrometric analysis by the method for mass spectrometry of the present invention. The laser energy used was 35 mJ, and the result is illustrated in FIG. 35. With reference to FIG. 35, it is obvious that the method for mass spectrometry of the present invention is capable of conducting analysis directly on milk, and is capable of obtaining corresponding results, where signals having m/z values of 1143.4, 1205.2, 1263.4, 1336.5, 1414.4 and 1500.0 (n=16) are all signals generated by casein (a protein having molecular weight of 24000).

Exemplary Applications 9 and 10—Mass Spectrometric Analysis Conducted on Tissue Sections under Positive Ion Mode

In exemplary applications 9 and 10, tissue sections obtained from pig liver and chicken liver, each having a thickness of 30 μm were used as the sample for conducting the method for mass spectrometry according to the present invention. The samples used, the figure numbers of the obtained mass spectrum, and the detected signals for exemplary applications 9 and 10 are tabulated in Table 6 below.

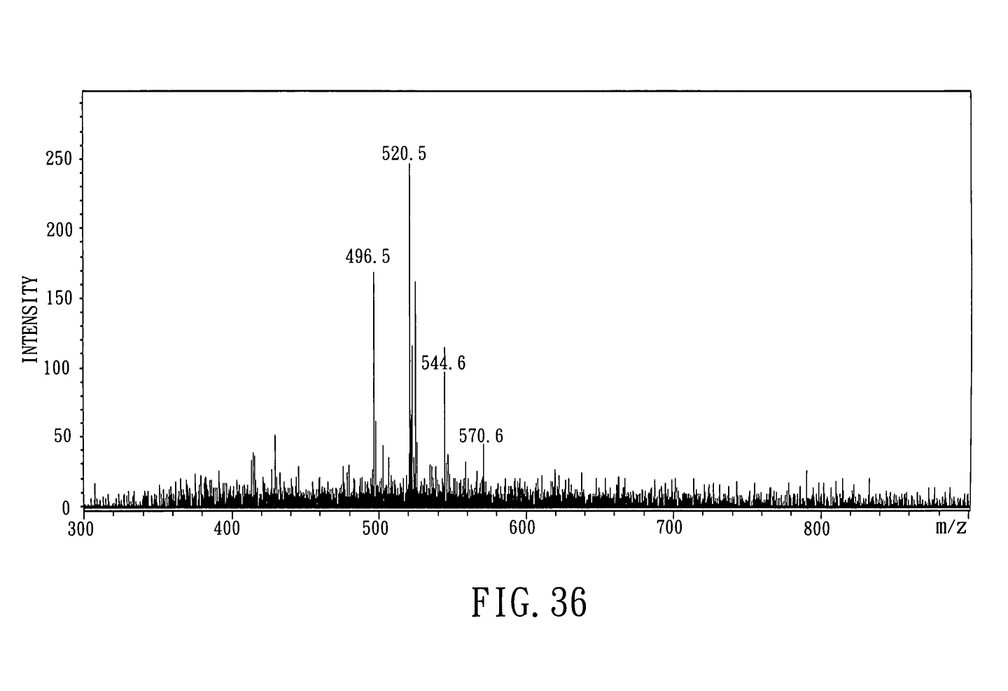

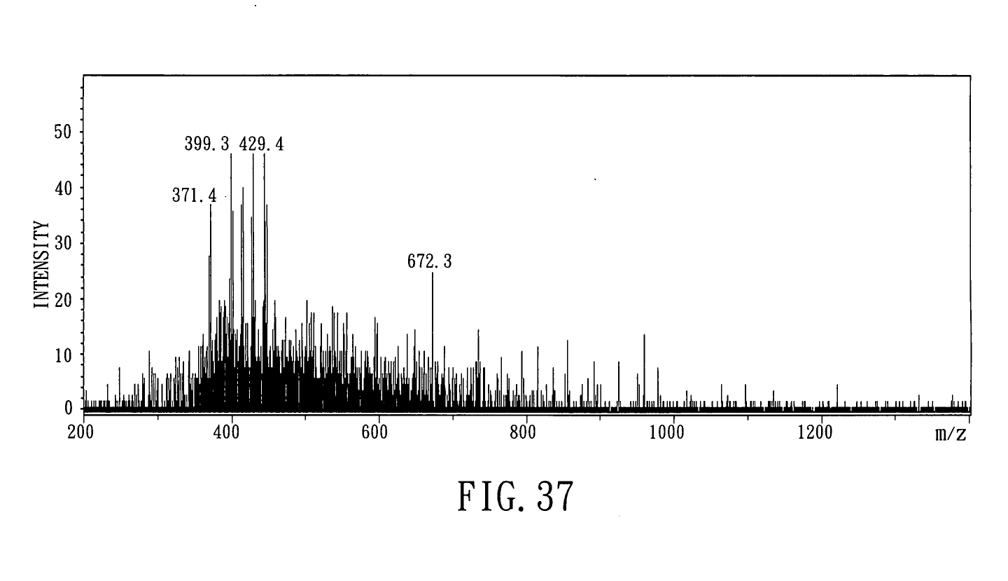

TABLE 6

| | | | | Detected |
|---|---|---|---|---|
| | Laser | | Mass | signals |
| Application | energy | Sample | spectrum | (m/z) |
| 9 | 26 mJ | Pig liver | FIG. 36 | 496.5, |
| | | | | 520.5, |
| | | | | 544.6, 570.6 |
| 10 | 26 mJ | Chicken | FIG. 37 | 371.4, |
| | | liver | | 399.3, |
| | | | | 429.4, 672.3 |

With reference to related information known in the field, the obtained signals are all generated from lipid.

### Exemplary Applications 11-13—Mass Spectrometric Analysis Conducted on Human Bile Juice

In exemplary application 11 to 13, the samples used (provided privately), the laser energy, the electrospray mode, the figure numbers of obtained mass spectra, and the detected signals are tabulated in Table 7. According to reference information in the field, the detected signals are generated from lipid.

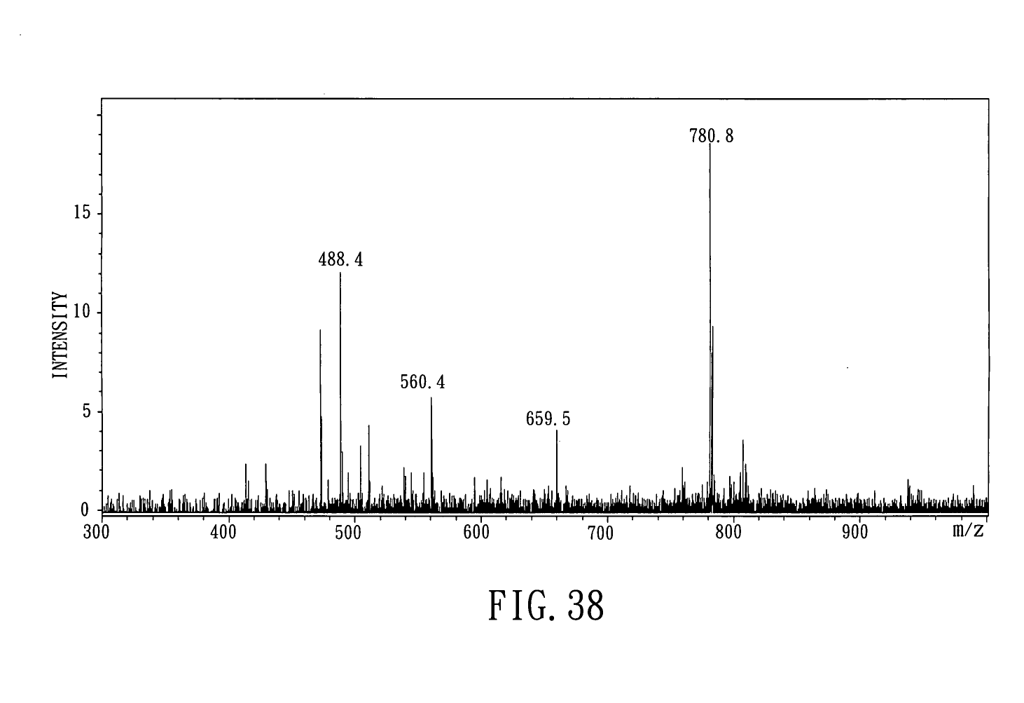

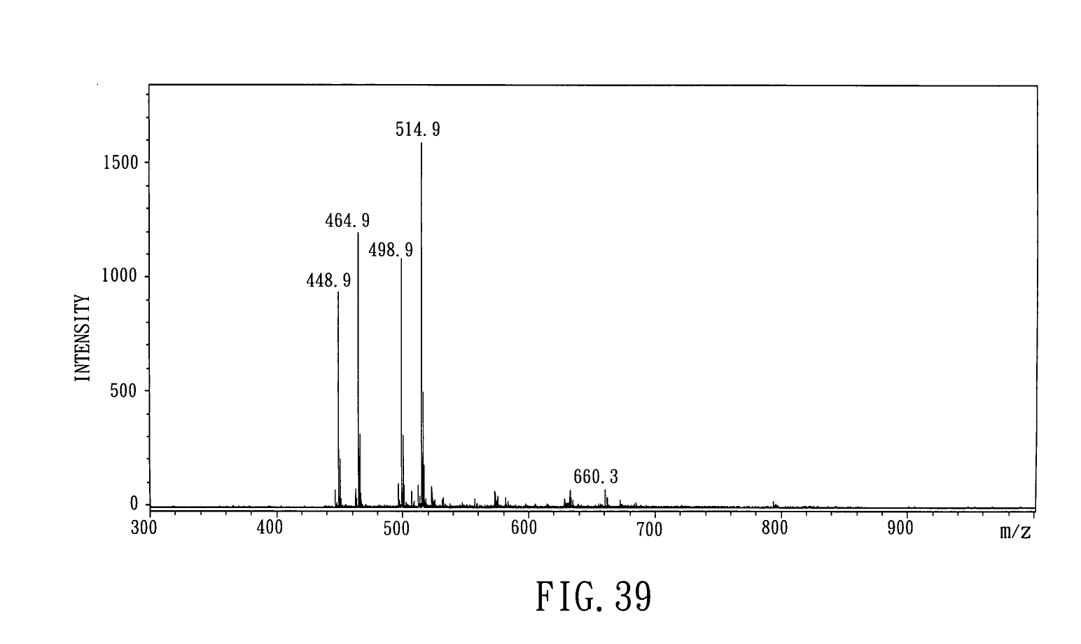

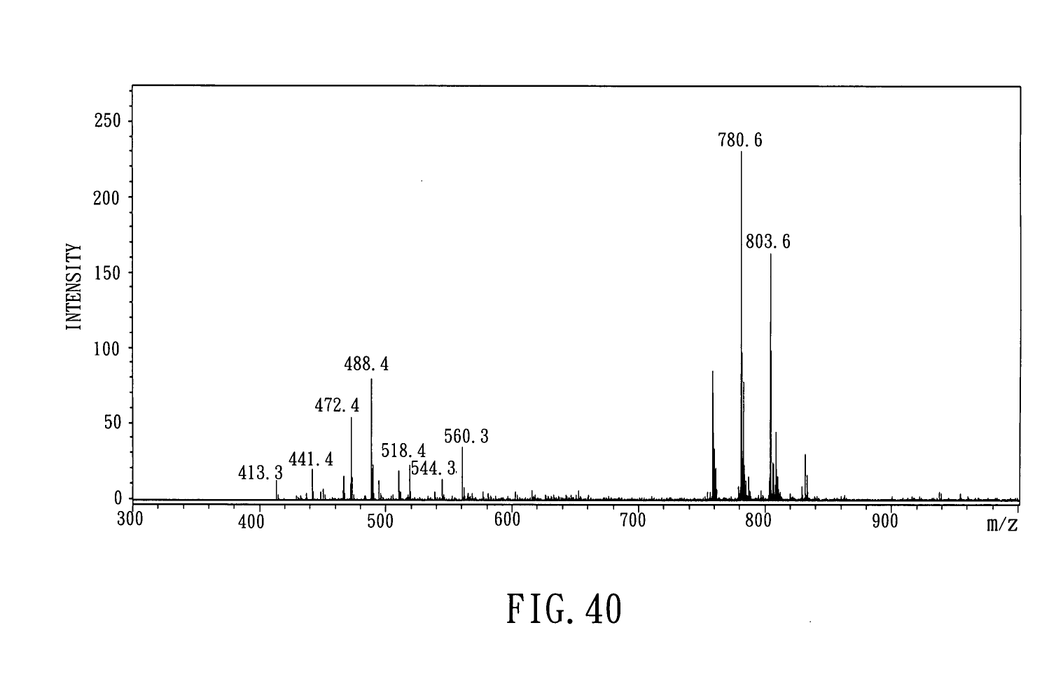

TABLE 7

| Ap- | | Laser | Electrospray | Mass | Detected |
|---|---|---|---|---|---|
| plication | Sample | energy | mode | spectrum | signals |
| 11 | Dehydrated | 18 mJ | Positive ion | FIG. 38 | 488.4, |
| | sample | | mode | | 560.4, |
| | obtained | | | | 659.5, |
| | from bile | | | | 780.8 |
| 12 | juice | 18 mJ | Negative ion | FIG. 39 | 448.9, |
| | | | mode | | 464.9, |
| | | | | | 498.9, |
| | | | | | 514.9, |
| | | | | | 660.3 |
| 13 | Bile juice | 35 mJ | Positive ion | FIG. 40 | 413.3, |
| | | | mode | | 441.4, |
| | | | | | 472.4, |
| | | | | | 488.4, |
| | | | | | 518.4, |
| | | | | | 544.3, |
| | | | | | 560.3, |
| | | | | | 780.6, |
| | | | | | 803.6 |

Exemplary Application 14—Mass Spectrometric Analysis Conducted on Human Ascitic Fluid under Positive ton Mode

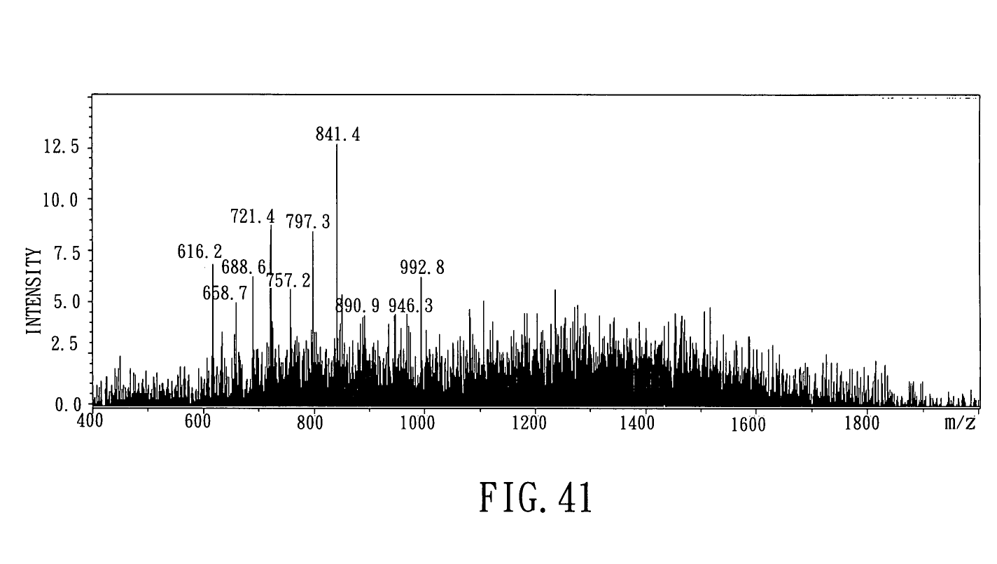

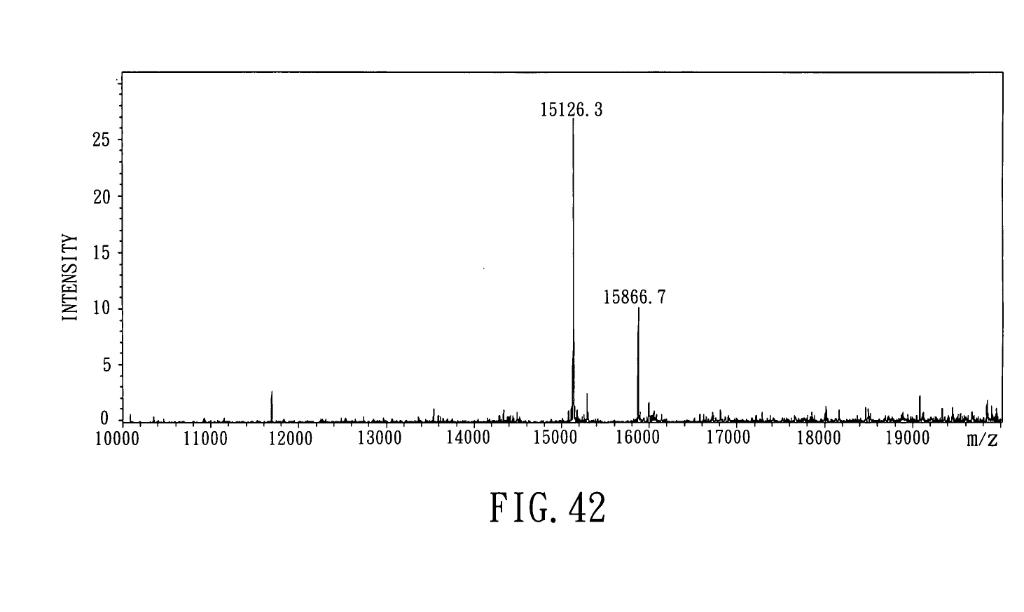

In exemplary application 14, ascitic fluid (provided privately) was used directly as the sample for conducting the method for mass spectrometry according to the present invention. The laser energy was 39 mJ, and the resultant mass spectra are illustrated in FIG. 41 and FIG. 42, where FIG. 42 is a convoluted mass spectrum of FIG. 41. In FIG. 41, the signals having m/z values of 616.2 (generated from hematin), 658.7, 688.6, 721.4, 757.2, 797.3, 841.4, 890.9, 946.3, and 992.8 are all generated from analytes with molecular weights of 15126.3 and 15866.7, which respectively corresponds to hemoglobin α chain and hemoglobin β chain. This indicates that blood is present in the ascitic fluid sample. As compared to other analytes, hemoglobin a chain and hemoglobin β chain are more easily detectable by LIAD.

With reference to the results described hereinabove with respect to the experiments and exemplary applications, it can be shown that the method for mass spectrometry that combines electrospray-assisted ionization (ESI) and laser-induced acoustic desorption ionization (LIAD) according to the present invention is capable of conducting analysis directly on samples of various forms. In particular, the method for mass spectrometry according to the present invention is capable of conducting mass spectrometric analysis on both solid and liquid samples that are relatively complicated in composition, such as biological fluids, tissue sections, ink, chemicals, protein solutions, amino acid solutions, etc., so as to successfully obtain complete qualitative information about the analytes.

In sum, the method for mass spectrometry according to the present invention not only is capable of conducting mass spectrometric analysis on various kinds of samples, but the desorbed analytes tend to form multivalent ionized analytes, such that the detected signals have relatively low m/z values. In addition, ionization efficiency of the method for mass spectrometry according to the present invention is relatively high, thereby results in relatively strong signals, and in turn relatively good detection sensitivity and good reproducibility. Furthermore, the desorbed analytes obtained through the method for mass spectrometry according to the present invention tend to have more complete structures. Moreover, it has been verified through experimentation and applications presented above that the method for mass spectrometry according to the present invention is successful in detecting macromolecules, such as proteins, in samples. This characteristic allows the method for mass spectrometry according to the present invention to be applicable in the analysis and identification of proteins.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A mass spectrometer comprising:
a receiving unit disposed to admit therein ionized analytes that are derived from a sample, and including a mass analyzer disposed for analyzing the ionized analytes; and
an electrospray unit including a reservoir for accommodating a liquid electrospray medium, and a nozzle which is disposed downstream of said reservoir, and which is configured to sequentially form a liquid drop of said electrospray medium thereat, said nozzle being spaced apart from said receiving unit in a longitudinal direction so as to define a traveling path;
a voltage supplying member disposed to establish between said nozzle and said receiving unit a potential difference which is of an intensity such that the liquid drop is laden with a plurality of charges, and such that the liquid drop is forced to leave said nozzle as a multiple-charged one for heading toward said receiving unit along the traveling path;
a substrate having a sample surface on which the sample is placed, and an irradiated surface opposite to said sample surface; and
a laser transmission mechanism disposed to irradiate said irradiated surface of said substrate;
wherein said substrate is made from a material capable of permitting propagation of laser energy therethrough such that upon irradiation by said laser transmission mechanism, laser energy is passed on to at least one of the analytes contained in the sample via said substrate so that said at least one of the analytes is desorbed to fly along a flying path which intersects the traveling path of the multiple-charged liquid drops of said electrospray medium so as to enable said at least one of the analytes to be occluded in said multiple-charged liquid drops;
wherein as a result of dwindling in size of the multiple-charged liquid drops when approaching said receiving unit from said nozzle of said electrospray unit along the traveling path, charges of the liquid drops will pass on to said at least one of the analytes occluded therein to form a corresponding one of the ionized analytes.

2. The mass spectrometer assembly as claimed in claim 1, wherein the material of said substrate has an ablation threshold that is lower than a laser fluence of said laser transmission mechanism.

3. The mass spectrometer assembly as claimed in claim 1, wherein the material of said substrate is selected from the group consisting of titanium, aluminum, iron, gold, silicon, and copper.

4. The mass spectrometer assembly as claimed in claim 1, wherein the material of said substrate is aluminum.

5. The mass spectrometer assembly as claimed in claim 1, wherein said substrate measures up to 600 μm in thickness between said sample surface and said irradiating surface.

6. The mass spectrometer assembly as claimed in claim 1, wherein said laser transmission mechanism is selected from the group consisting of a nitrogen laser, an argon ion laser, a helium-neon laser, a carbon dioxide laser, a garnet laser and an infrared laser.

7. The mass spectrometer assembly as claimed in claim 6, wherein said laser transmission mechanism is an infrared laser.

8. The mass spectrometer assembly as claimed in claim 1, wherein a light spot is formed on said irradiated surface of said substrate upon irradiation by said laser transmission mechanism, a unit area of the light spot has a laser energy of at least 1.11*10⁸ W/cm².

9. The mass spectrometer assembly as claimed in claim 8, wherein the unit area of the light spot has a laser energy that ranges from 2.22*10⁸ W/cm² to 1.11*10⁹ W/cm².

10. A method for mass spectrometry, comprising the steps of:
(a) providing a substrate that has a sample surface and an irradiated surface opposite to the sample surface, the substrate being made from a material capable of permitting propagation of laser energy therethrough;
(b) providing a sample that is placed on the sample surface of the substrate;
(c) providing a receiving unit that is disposed to admit therein ionized analytes derived from the sample, and that includes a mass analyzer disposed for analyzing the ionized analytes;
(d) providing an electrospray unit that includes a reservoir for accommodating a liquid electrospray medium, and a nozzle which is disposed downstream of the reservoir, and which is configured to sequentially form a liquid drop of the electrospray medium thereat, the nozzle being spaced apart from the receiving unit in a longitudinal direction so as to define a traveling path;
(e) providing a voltage supplying member that is disposed to establish between the nozzle and the receiving unit a potential difference which is of an intensity such that the liquid drop is laden with a plurality of charges, and such that the liquid drop is forced to leave the nozzle as a multiple-charged one for heading toward the receiving unit along the traveling path; and
(f) providing a laser transmission mechanism that is disposed to irradiate the irradiated surface of the substrate such that, upon irradiating the irradiated surface of the substrate, laser energy is passed on to at least one of the analytes contained in the sample via the substrate so that the at least one of the analytes is desorbed to fly along a flying path which intersects the traveling path of the multiple-charged liquid drops of the electrospray medium so as to enable the at least one of the analytes to be occluded in the multiple-charged liquid drops, and such that as a result of dwindling in size of the multiple-charged liquid drops when approaching the receiving unit from the nozzle of the electrospray unit along the traveling path, charges of the liquid drops will pass on to the at least one of the analytes occluded therein to form a corresponding one of the ionized analytes.

11. The method as claimed in claim 10, wherein the material of the substrate has an ablation threshold that is lower than a laser fluence of the laser transmission mechanism.

12. The method as claimed in claim 10, wherein the material of the substrate is selected from the group consisting of titanium, aluminum, iron, gold, silicon, and copper.

13. The method as claimed in claim 12, wherein the material of the substrate is aluminum.

14. The method as claimed in claim 10, wherein the substrate measures up to 600 μm in thickness between the sample surface and the irradiating surface.

15. The method as claimed in claim 10, wherein the laser transmission mechanism is selected from the group consisting of a nitrogen laser, an argon ion laser, a helium-neon laser, a carbon dioxide laser, a garnet laser and an infrared laser.

16. The method as claimed in claim 15, wherein the laser transmission mechanism is an infrared laser.

17. The method as claimed in claim 10, wherein a light spot is formed on the irradiated surface of the substrate upon irradiation by the laser transmission mechanism, a unit area of the light spot has a laser energy of at least 1.11*10⁸ W/cm².

18. The method as claimed in claim 17, wherein the unit area of the light spot has a laser energy that ranges from 2.22*10⁸ W/cm² to 1.11*10⁹ W/cm².
